(19) United States
(12) Patent Application Publication
(10) Pub. No.: US 2026/0330589 A1
(43) Pub. Date: Oct. 22, 2026

(54) AREA OPTIMIZATION FOR COMPUTE GATING IN FOVEATION

(71) Applicant: QUALCOMM Incorporated, San Diego, CA (US)

(72) Inventors: Shrey Shailesh GADIYA, Bengaluru (IN); Saurabh AGGARWAL, Bengaluru (IN); Abhijeet DEY, San Diego, CA (US); Saurabh Ramesh GANGURDE, Bangalore (IN); Prasant Shekhar SINGH, Bangalore (IN)

(21) Appl. No.: 19/182,435

(22) Filed: Apr. 17, 2025

(51) Int. Cl. G06T 1/60; G06T 1/20

(52) U.S. Cl. CPC G06T 1/60; G06T 1/20

(57) ABSTRACT

This disclosure provides systems, devices, apparatus, and methods, including computer programs encoded on storage media, for area optimization for compute gating in foveation. A data processor may obtain, at a contiguous portion of memory, data lines associated with first pixels for a first FOV of image data. The first and second FOVs have first and second image data resolutions. The second FOV includes an overlap of, and is surrounded on at least two sides by, the first FOV. Pixel data associated with the overlap is outside the data lines. The data processor may determine, with reference to a data line, the contiguous portion of memory includes a number of prior data lines and a number of subsequent data lines. The data processor may output, from the contiguous portion of memory, the data line based on the number of prior data lines and the number of subsequent data lines.

### TECHNICAL FIELD

The present disclosure relates generally to processing systems, and more particularly, to one or more techniques for data processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for data and graphics processing may utilize concurrent processing of multiple streams for foveation of image data using a multi-context architecture, but may not address redundancy of information between the multiple streams, and buffering data for multiple streams utilizes buffers sized to accommodate the maximum data line width for each stream simultaneously. There is a need for improved techniques in data and graphics processing to reduce total buffer sizes and information redundancy.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus includes a memory; and a processor coupled to the memory and, based on information stored in the memory, the processor is configured to: obtain, at a contiguous portion of memory, a first set of data lines associated with first pixels for a first field of view (FOV) of image data, where the first FOV of the image data corresponds to a first resolution for the image data and a second FOV of the image data corresponds to a second resolution, where the second FOV includes a first overlap of the first FOV and is surrounded on at least two second FOV sides by the first FOV, and where first data for pixels associated with the first overlap of the first FOV is outside of the first set of data lines; to determine, with reference to a first data line of the first set of data lines, that the contiguous portion of memory includes a first number of prior data lines of the first set of data lines and a second number of subsequent data lines of the first set of data lines, where the first number of prior data lines is prior to the second number of subsequent data lines in the first set of data lines; and to output, from the contiguous portion of memory, the first data line of the first set of data lines based on the first number of prior data lines and the second number of subsequent data lines.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example image or surface in accordance with one or more techniques of this disclosure.

FIG. 4 illustrates an example display framework including a display processor and a display in accordance with one or more techniques of this disclosure.

FIG. 5 illustrates an example of foveation in accordance with one or more techniques of this disclosure.

FIG. 6 illustrates an example of foveation in accordance with one or more techniques of this disclosure.

FIG. 7 illustrates an example of memory area reduction for foveation via compute gating in accordance with one or more techniques of this disclosure.

FIG. 8 illustrates an example of memory area reduction for foveation via compute gating in accordance with one or more techniques of this disclosure.

FIG. 9 illustrates an example of memory area reduction for foveation via compute gating in accordance with one or more techniques of this disclosure.

FIG. 10 illustrates an example of memory area reduction for foveation via compute gating in accordance with one or more techniques of this disclosure.

FIG. 11 illustrates an example of memory area reduction for foveation via compute gating in accordance with one or more techniques of this disclosure.

FIG. 12 illustrates an example of memory area reduction for foveation via compute gating in accordance with one or more techniques of this disclosure.

FIG. 13 is a call flow diagram illustrating example communications between a CPU and a contiguous portion of memory in accordance with one or more techniques of this disclosure.

FIG. 14 is a flowchart of an example method of data processing in accordance with one or more techniques of this disclosure.

FIG. 15 is a flowchart of an example method of data processing in accordance with one or more techniques of this disclosure.

### DETAILED DESCRIPTION

Various aspects of systems, apparatuses, computer program products, and methods are described more fully hereinafter with reference to the accompanying drawings.

This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory).

Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit. As used herein, the term “contiguous portion of memory” may refer to a memory allocation of memory blocks stored sequentially in adjacent memory locations. As used herein, the term “data line” may refer to a line in a memory or a buffer that stores pixel data for a corresponding line of a foveated sensor. As used herein, instances of the term “field of view” and/or “FOV” may refer to a region associated with the focus and eye-gaze of a user, such as types of fovea regions, periphery regions, etc. As used herein, instances of the terms “video see-through sensing” and/or “VST sensing” may refer to capturing and displaying a real-time/near real-time video feed that allows a user to see real-world objects or environments that optionally may be overlaid or combined with virtual content. As used herein, instances of the terms “foveated sensor” and/or “foveation sensor” may refer to a sensor configured to identify/determine and/or take as an input an area of an image frame associated with user gaze and to determine FOVs, and locations thereof, with associated resolutions that correspond to the areas of the image data. As used herein, the term “a number of prior data lines” may refer to a number of data lines that come before a given data line, for a same FOV, in a contiguous portion of memory and/or buffer. As used herein, the term “a number of subsequent data lines” may refer to a number of data lines that come after a given data line, for a same FOV, in a contiguous portion of memory and/or buffer. As used herein, the terms “gating” and/or “compute gating” may refer to skipping and/or refraining from processing and/or storing data based on a gating condition, e.g., the data is redundant or duplicative. As used herein, the term “data processing” may refer to the processing of data and/or information associated with graphics processing and/or display processing.

Examples of concurrent processing of multiple streams for foveation of image data may utilize a multi-context architecture. However, the redundancy of information between the multiple streams, and buffering redundant data for multiple streams utilizing buffers sized to accommodate the maximum data line width for each stream simultaneously, leads to additional overhead in power, processing/transmission times, and hardware utilization (e.g., buffer size/area).

Aspects herein provide for memory area reduction for foveation, e.g., via compute gating. Foveated rendering with gating prevents obtaining and storing data from overlapping regions of image data. For instance, in a use case with 3 levels of foveation, the periphery region includes the entire frame and the mid-fovea region includes the entire fovea region. Thus, the area that represents the fovea region overlaps the mid-fovea region and that data in that region for the mid-fovea may be skipped or excluded (e.g., may remain un-stored). Aspects provide for a dynamically allocated buffer such that a maximum number of data lines above and data lines below, for each region, are stored based on an N×N kernel configuration (e.g., according to the context utilized by the kernel for data lines above and/or below the current data line in the buffer). In contrast to naïve approaches, which may store more than N data lines if simply storing line-by-line.

Aspects provide for disabling or refraining from processing of pixels in periphery and/or mid-fovea regions (e.g., FOVs generally) that respectively overlap with pixels in the mid-fovea and/or fovea regions. Aspects include margins to buffer areas that may account for staggered timing of arrival for data lines to improve image quality. In such aspects, the margins to buffer areas may still allow for an overall smaller buffer area than examples that do not utilize gating. Aspects enable buffer sizes to be configured dynamically based on numbers of data lines, e.g., for context of streams, utilized for kernel configurations. Accordingly, aspects improve power, processing/transmission times, and hardware utilization (e.g., buffer size/area) via memory area reduction for foveation.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

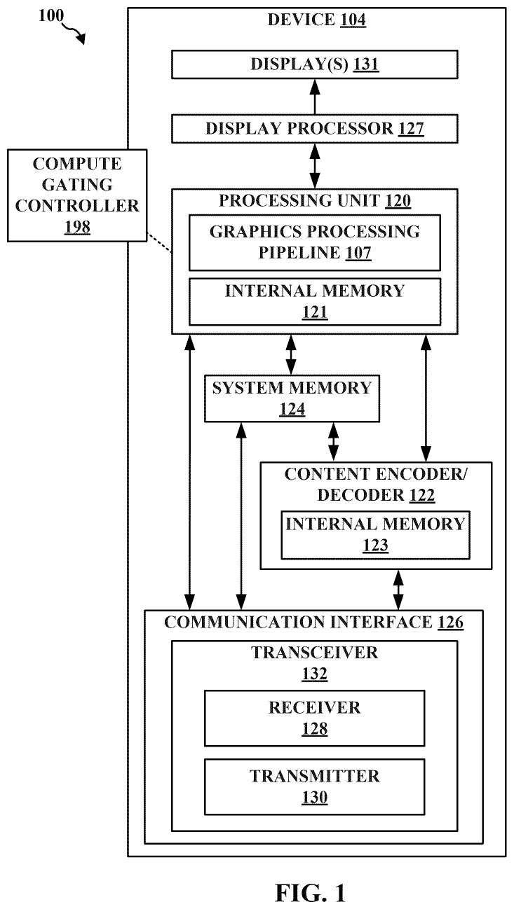

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a compute gating controller 198 configured to obtain, at a contiguous portion of memory, a first set of data lines associated with first pixels for a first FOV of image data, where the first FOV of the image data corresponds to a first resolution for the image data and a second FOV of the image data corresponds to a second resolution, where the second FOV includes a first overlap of the first FOV and is surrounded on at least two second FOV sides by the first FOV, and where first data for pixels associated with the first overlap of the first FOV is outside of the first set of data lines. The compute gating controller 198 may be configured to determine, with reference to a first data line of the first set of data lines, that the contiguous portion of memory includes a first number of prior data lines of the first set of data lines and a second number of subsequent data lines of the first set of data lines, where the first number of prior data lines is prior to the second number of subsequent data lines in the first set of data lines. The compute gating controller 198 may be configured to output, from the contiguous portion of memory, the first data line of the first set of data lines based on the first number of prior data lines and the second number of subsequent data lines. The compute gating controller 198 may be further configured to obtain, at the contiguous portion of memory and after the first set of data lines, a second set of data lines associated with second pixels for the second FOV of the image data, to determine, with reference to a second data line of the second set of data lines, that the contiguous portion of memory includes a third number of prior data lines of the second set of data lines and a fourth number of subsequent data lines of the second set of data lines, and to output, from the contiguous portion of memory, the second data line of the second set of data lines based on the third number of prior data lines and the fourth number of subsequent data lines. The compute gating controller 198 may be further configured to obtain, at the contiguous portion of memory before the second set of data lines and after the first set of data lines, a third set of data lines associated with third pixels for a third FOV of the image data, where: the third FOV of the image data corresponds to a third resolution for the image data, where the third FOV includes a second overlap of the first FOV and is surrounded on at least two third FOV sides by the first FOV, the second FOV is surrounded on the at least two second FOV sides by the third FOV and includes a third overlap of the third FOV, the first set of data lines is exclusive of second data for pixels associated with the second overlap of the first FOV, and the third set of data lines is exclusive of third data for pixels associated with the third overlap of the third FOV, to determine, with reference to a third data line of the third set of data lines, that the contiguous portion of memory includes a fifth number of prior data lines of the third set of data lines and a sixth number of subsequent data lines of the third set of data lines, where the fifth number of prior data lines is prior to the sixth number of subsequent data lines in the third set of data lines, and to output, from the contiguous portion of memory, the third data line of the third set of data lines based on the fifth number of prior data lines and the sixth number of subsequent data lines. Although the following description may be focused on data and/or graphics processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

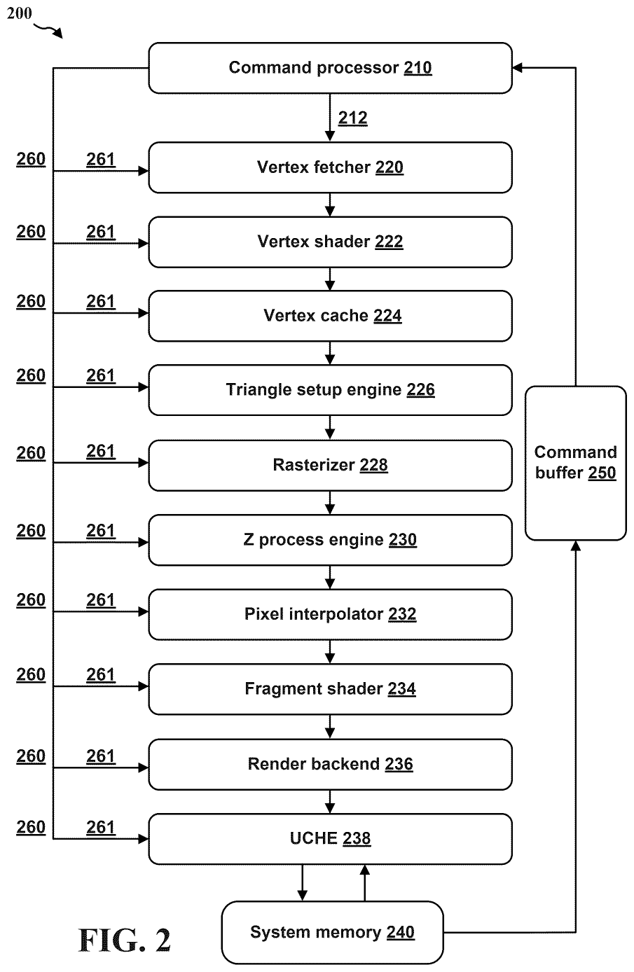

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

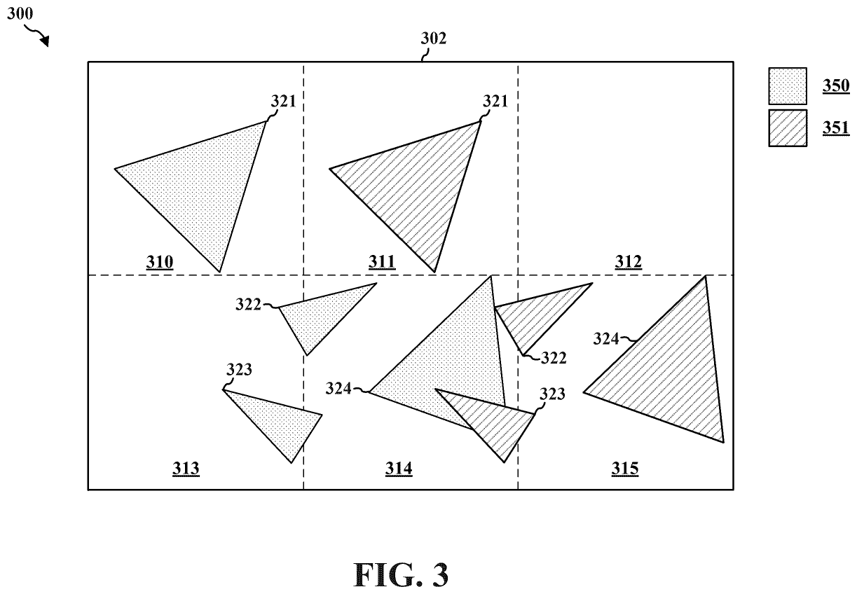

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processors can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

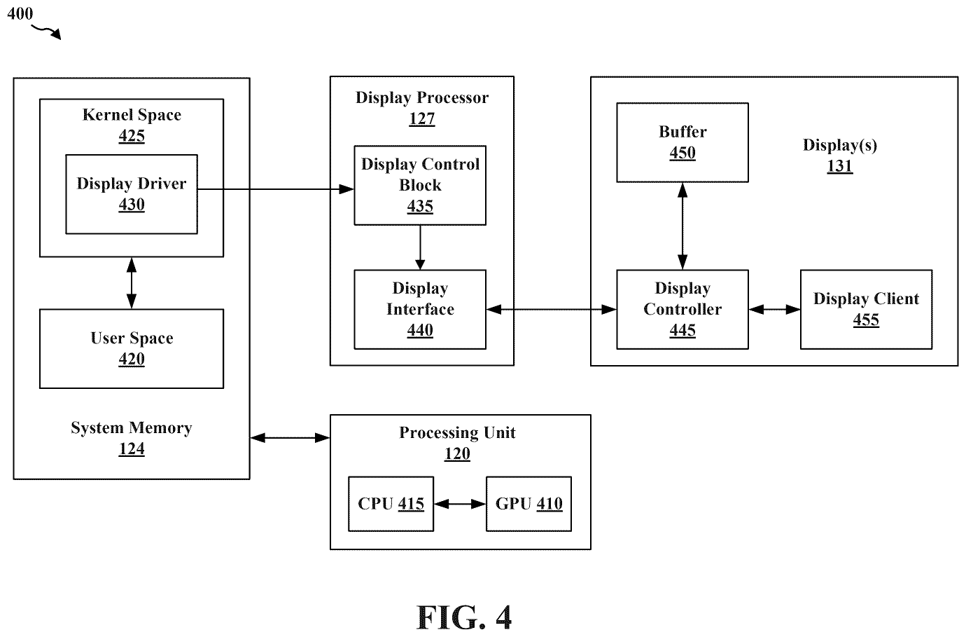

FIG. 4 is a block diagram 400 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 410 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 410 may be controlled based on one or more graphics processing commands provided by a CPU 415. The CPU 415 may be configured to execute multiple applications concurrently. In some cases, each of the concurrently executed multiple applications may utilize the GPU 410 simultaneously. Processing techniques may be performed via the processing unit 120 output a frame over physical or wireless communication channels.

The system memory 124, which may be executed by the processing unit 120, may include a user space 420 and a kernel space 425. The user space 420 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 425 may further include a display driver 430. The display driver 430 may be configured to control the display processor 127. For example, the display driver 430 may cause the display processor 127 to compose a frame and transmit the data for the frame to a display.

The display processor 127 includes a display control block 435 and a display interface 440. The display processor 127 may be configured to manipulate functions of the display(s) 131 (e.g., based on an input received from the display driver 430). The display control block 435 may be further configured to output image frames to the display(s) 131 via the display interface 440. In some examples, the display control block 435 may additionally or alternatively perform post-processing of image data provided based on execution of the system memory 124 by the processing unit 120.

The display interface 440 may be configured to cause the display(s) 131 to display image frames. The display interface 440 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 450.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 450. For example, when a Vsync pulse is generated, the display processor 127 may output new graphical content to the buffer 450. Thus, generation of the Vsync pulse may indicate that current graphical content has been rendered at the buffer 450.

Frames are displayed at the display(s) 131 based on a display controller 445, a display client 455, and the buffer 450. The display controller 445 may receive image data from the display interface 440 and store the received image data in the buffer 450. In some examples, the display controller 445 may output the image data stored in the buffer 450 to the display client 455. Thus, the buffer 450 may represent a local memory to the display(s) 131. In some examples, the display controller 445 may output the image data received from the display interface 440 directly to the display client 455.

The display client 455 may be associated with a touch panel that senses interactions between a user and the display(s) 131. As the user interacts with the display(s) 131, one or more sensors in the touch panel may output signals to the display controller 445 that indicate which of the one or more sensors have sensor activity, a duration of the sensor activity, an applied pressure to the one or more sensor, etc. The display controller 445 may use the sensor outputs to determine a manner in which the user has interacted with the display(s) 131. The display(s) 131 may be further associated with/include other devices, such as a camera, a microphone, and/or a speaker, that operate in connection with the display client 455.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 410 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

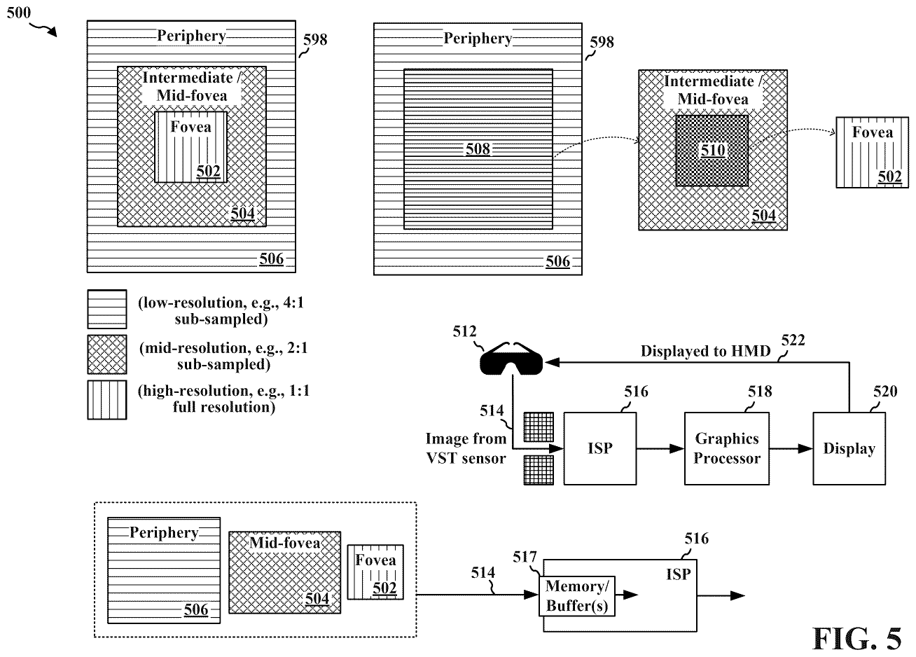

FIG. 5 illustrates a diagram 500 of an example of foveation in accordance with one or more techniques of this disclosure. Diagram 500 shows an example image frame 598 (e.g., image data) that includes a fovea region 502 (or a fovea FOV), e.g., based on a center of eye-gaze of a user, with a higher or a full resolution (e.g., a 1:1 sub-sampled resolution of the image frame 598), a periphery region 506 (or a periphery FOV) having a lower resolution (e.g., a 4:1 sub-sampled resolution of the image frame 598), and an intermediate region such as a mid-fovea region 504 (or a mid-fovea FOV) having a resolution between the fovea region 502 and the periphery region 506 (e.g., a 2:1 sub-sampled resolution of the image frame 598). Some examples of foveation provide for modes of two or three foveation levels. For instance, a two-level configuration may include one fovea region and one periphery region, while a three-level configuration may include one fovea region, one intermediate or mid-fovea region, and one periphery region, e.g., as shown for the image frame 598. In some examples, a head-mounted device (HMD) 512 may receive an image frame 522 from a display panel 520 and/or a display processor. The HMD 512 may generate an image 514 via a VST sensor, e.g., the image 514 is a VST image may comprise a camera image frame combined with a virtual image frame for display to a user. The image 514 may include a fovea region, a periphery region, and optionally, an intermediate or mid-fovea region as described above. The HMD 512 may then provide the image 514 to an image signal processor (ISP) 516 for processing, which in turn may be provided for further downstream processing by a graphics processor 518 and/or a display processor and/or display panel 520. The above flow may be repeated for displaying the image 514 to the HMD 512. Based on eye-gaze location of a user, the VST sensor and/or foveated sensor may include the fovea, intermediate or mid-fovea, periphery regions for the image 514.

Foveation examples, as shown in diagram 500, may include storing and/or buffering, e.g., a memory 517, the entirety of the fovea region 502, the mid-fovea region 504, and the periphery region 506, as data line inputs (e.g., without gating), for further processing of the image frame 598 (e.g., of image data). However, as noted above, the periphery region 506 includes an overlap region 508 that is covered by the mid-fovea region 504, and the mid-fovea region 504 also includes an overlap region 510 that is covered by the fovea region 502. Accordingly, data for pixels associated with the overlap region 508 and the overlap region 510 are duplicative or redundant (e.g., pixel data for these regions also exists at a higher resolution), and processing or storage of the data for these pixels increases overhead for power, processing times, transmissions, and area of the memory 517.

Aspects herein, as described in further detail below, utilize gating in foveation disable or refrain from the processing and/or storage of data for certain pixels in periphery and mid-fovea streams that overlap with the pixels in mid-fovea and fovea, respectively

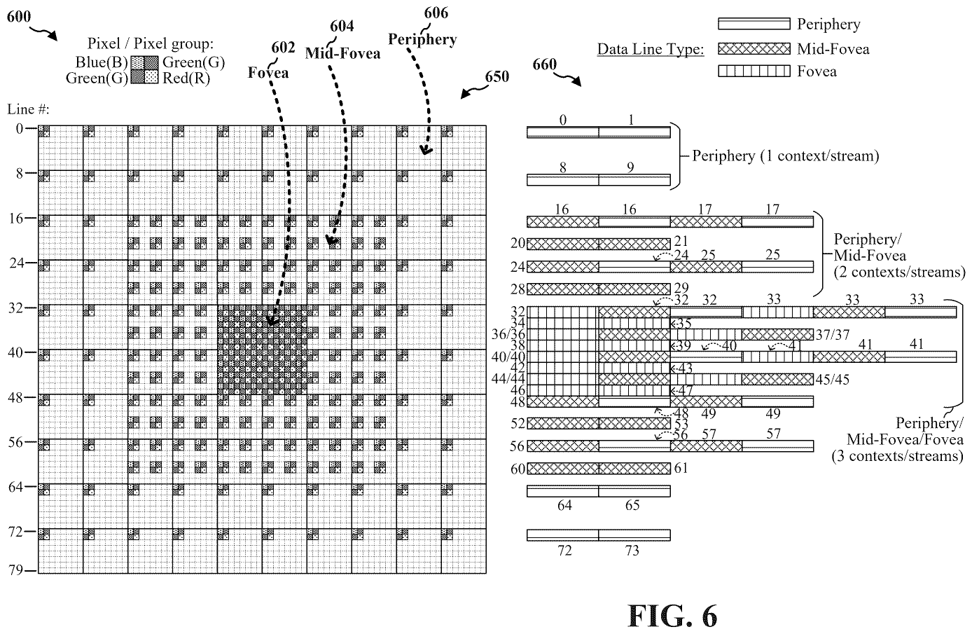

FIG. 6 illustrates a diagram 600 of an example of foveation in accordance with one or more techniques of this disclosure. Diagram 600 shows foveation 650, without gating, via a foveated sensor with a sensor width and a sensor height of 80 units (e.g., pixels, pixel groups, and/or the like), by way of example. A fovea 602 data height and data width are shown as 16 units (e.g., at full resolution, 1:1), a mid-fovea 604 data height and data width are shown as 48/2=24 units (e.g., at downscaled at 2:1), and a periphery 606 data height and data width are shown as 80/4=20 units (e.g., at downscaled at 4:1).

Also shown in diagram 600 are data lines 660 that correspond to the line numbers of the foveated sensor for the foveation 650. The data lines 660 represent all pixel data, without gating, for the fovea 602, the mid-fovea 604, and the periphery 606. As illustrated, for lines 32 and 33 and for lines 40 and 41 (e.g., where data lines for each of the three contexts of the fovea 602, the mid-fovea 604, and the periphery 606 are present), a maximum memory or buffer area or size may be based on either of these line pairs plus a number of prior lines and a number of subsequent lines (depending on the configuration of a N×N kernel associated with the memory or buffer and processing of the data lines 660). That is, an N×N kernel may utilized the context of a number of data lines before and after a given data line to process that given data line of a given stream or FOV, where the

$$number of lines = \frac{N - 1}{2} .$$

As one example, a 5×5 kernel may utilize 2 prior data lines (e.g., lines above) and 2 subsequent data lines (e.g., lines below) a given data line for context in its processing.

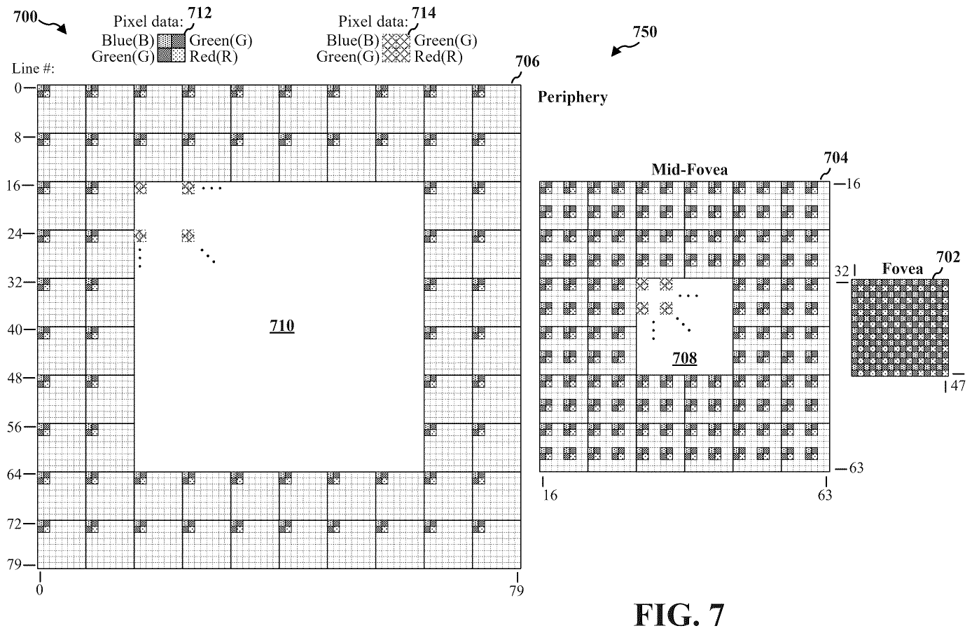

With reference to the data lines 660 associated with the foveation 650 without gating, and as noted above, the fovea 602 data width is shown as 16 units, the mid-fovea 604 data width is shown as 48/2=24 units, and the periphery 606 data width is shown as 80/4=20 units, which provides a total data width of 16+24+20=60 units. FIG. 7 shows an example aspect with gating by way of comparison.

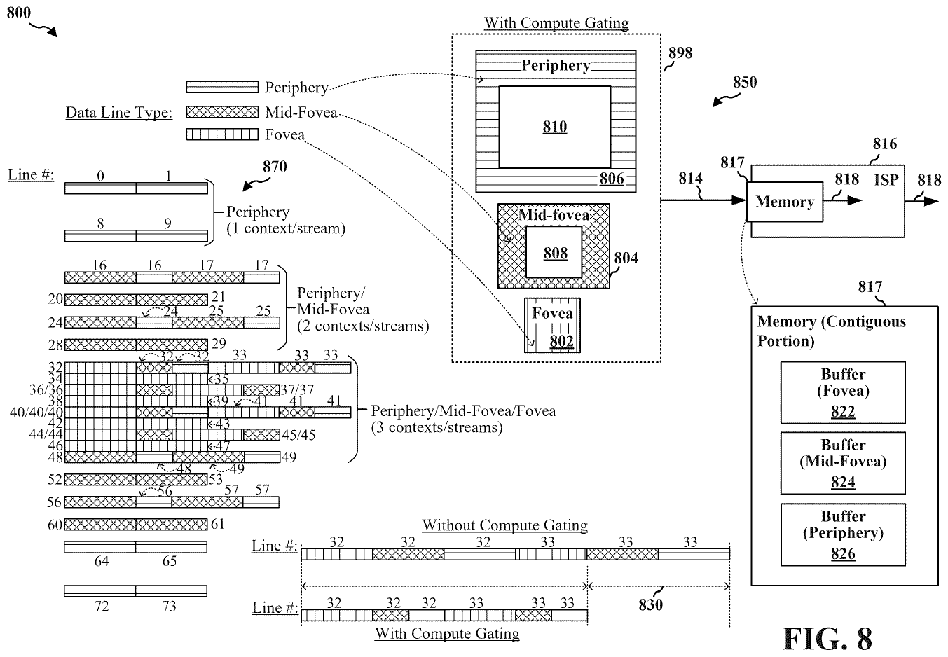

FIG. 7 illustrates a diagram 700 of an example of memory area reduction for foveation via compute gating in accordance with one or more techniques of this disclosure. Diagram 700 is described in conjunction with diagram 800 of FIG. 8, as provided below.

Diagram 700 shows gated foveation 750 via a foveated sensor, as in diagram 600 of FIG. 6, but with compute gating for memory area reduction, according to aspects herein. For instance, diagram 700 illustrates a fovea region 702, an example of a gated mid-fovea region 704 that excludes an overlap region 708, and an example of a gated periphery region 706 that excludes an overlap region 710. That is, pixel data associated with the overlap region 708 and with the overlap region 710 are gated such that this pixel data will not be processed and/or stored in a memory or buffer therefor.

The represented foveated sensor in diagram 700 has an example a sensor width and a sensor height of 80 units (e.g., pixels, pixel groups, and/or the like), by way of example. The fovea region 702 data height and data width are shown as 16 units (e.g., at full resolution, 1:1), the gated mid-fovea region 704 data height and data width are shown as 48/2=24, and 24−(16/2)=16 units (e.g., at downscaled at 2:1) with an ungated data height and data width of 24 units, and the gated periphery region 706 data height and data width are shown as 80/4=20, and 20−(24/2)=8 units (e.g., at downscaled at 4:1) with an ungated data height and data width of 20 units. Accordingly, the total data width for the gated foveation 750 in diagram 700 is 16+16+8=40 units, which is 20 fewer units that for the total data width of 16+24+20=60 units in diagram 600 in FIG. 6 for the foveation 650 without gating. For instance, memory or buffer width may be reduced via gating in the gated foveation 750 as the gated mid-fovea region 704 data width is less than a non-gated mid-fovea data width by a value of half of the fovea region 702 data width, and the gated periphery region 706 data width is less than a non-gated periphery data with by a value of half of the mid-fovea data width. That is, in this example based on the gated foveation 750, pixel data 712 may be utilized while pixel data 714 may not be stored in a memory or buffer may not be not utilized (e.g., the pixel data 714 in the overlap region 710 may correspond to unseen and unused (e.g., excluded) pixel data of the gated periphery region 706, and, the pixel data 714 in the overlap region 708 may correspond to unseen and unused (e.g., excluded) pixel data of the gated mid-fovea region 704.

FIG. 8 illustrates a diagram 800 of an example of memory area reduction for foveation via compute gating in accordance with one or more techniques of this disclosure. Diagram 800 is an aspects of diagram 700 in FIG. 7 and shows, for image data 898, a fovea region 802, a gated mid-fovea region 804 with an overlap region 808 excluded therefrom, and a gated periphery region 806 with an overlap region 810 excluded therefrom.

Aspects herein for memory area reduction for foveation via compute gating, e.g., gated foveation 850, as shown in diagram 800, enable processing and storing and/or buffering, e.g., at a contiguous portion of memory 817 for an ISP 816, of data lines for pixel data associated with the fovea region 802, the gated mid-fovea region 804 exclusive of the overlap region 808, and the gated periphery region 806 exclusive of the overlap region 810, as data line inputs 814 (e.g., via gating), for output 818 to further processing of the image data 898 via the ISP 816, a GPU, a display processing unit (DPU), and/or the like.

In aspects, the contiguous portion of memory 817 may include buffers for data lines of each FOV associated with the gated foveation 850. For example, the contiguous portion of memory 817 may include a buffer 826 that corresponds to data lines for the gated periphery region 806 (e.g., a first FOV), a buffer 822 that corresponds to data lines for the fovea region 802 (e.g., a second FOV), and buffer 824 that corresponds to data lines for the gated mid-fovea region 804 (e.g., a third FOV). Referring also to the gated foveation 750 of diagram 700 in FIG. 7, corresponding data lines 870 are shown for pixel data associated with the fovea region 802, the gated mid-fovea region 804 exclusive of the overlap region 808, and the gated periphery region 806 exclusive of the overlap region 810. A comparison for a data line 32 and a data line 33 of the data lines 870 for the gated foveation 750 is shown in contrast to data lines in foveation without gating (e.g., as in the data lines 660 for the foveation 650 without gating in diagram 600 of FIG. 6). As illustrated, the data line 32 and the data line 33 of the data lines 870 for the gated foveation 750 take less width 830 than corresponding data lines of non-gated examples based on the exclusion of pixel data for the overlap region 808 and the overlap region 810 from the contiguous portion of memory 817.

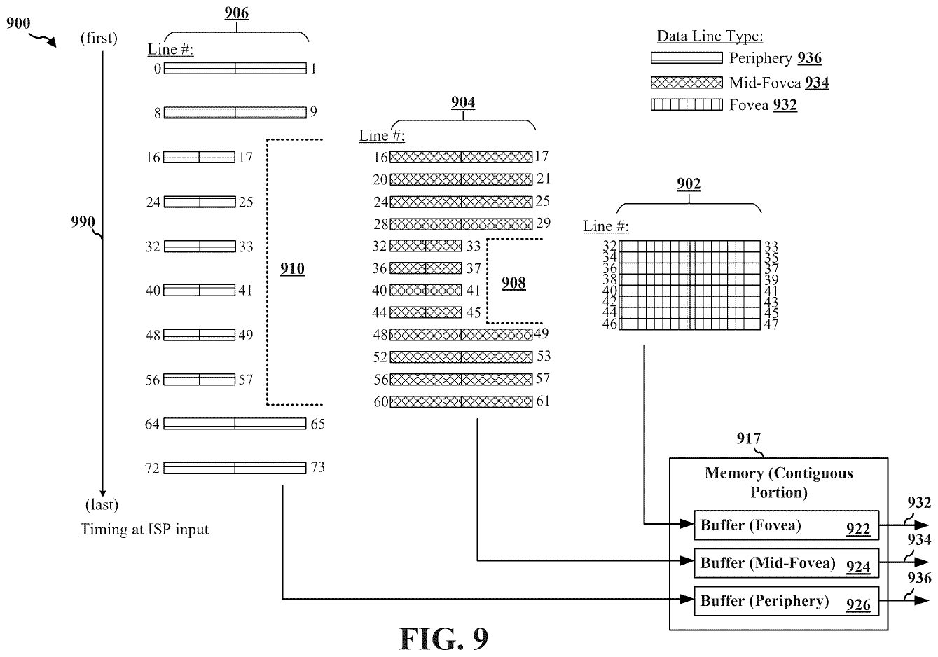

FIG. 9 illustrates a diagram 900 of an example of memory area reduction for foveation via compute gating in accordance with one or more techniques of this disclosure. Diagram 900 shows timing 990 at an ISP input for data lines associated with pixel data in gated foveation. Diagram 900 may be an aspect of diagram 700 in FIG. 7 and/or of diagram 800 in FIG. 8.

Data lines 932 for pixel data associated with a fovea region 902, data lines 934 associated with a gated mid-fovea region 904 excluding an overlap region 908, and data lines 936 associated with a gated periphery region 906 excluding an overlap region 910, are shown with respect to the timing 990 at the ISP input. As similarly described above with reference to FIG. 8, a contiguous portion of memory 917 for an ISP may include buffers for data lines of each FOV associated with the gated foveation represented by diagram 900. For example, the contiguous portion of memory 917 may include a buffer 926 that corresponds to data lines for the gated periphery region 906 (e.g., a first FOV), a buffer 922 that corresponds to data lines for the fovea region 902 (e.g., a second FOV), and buffer 924 that corresponds to data lines for the gated mid-fovea region 904 (e.g., a third FOV). In aspects, the buffer 922, the buffer 924, and the buffer 926 of the contiguous portion of memory 917 may each have a respective buffer size that is dynamically allocated.

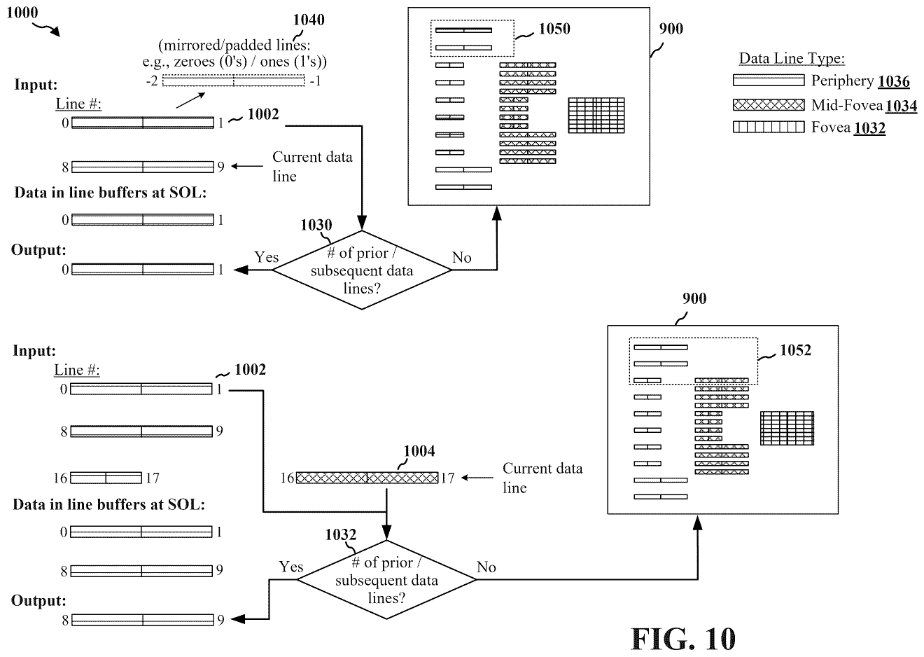

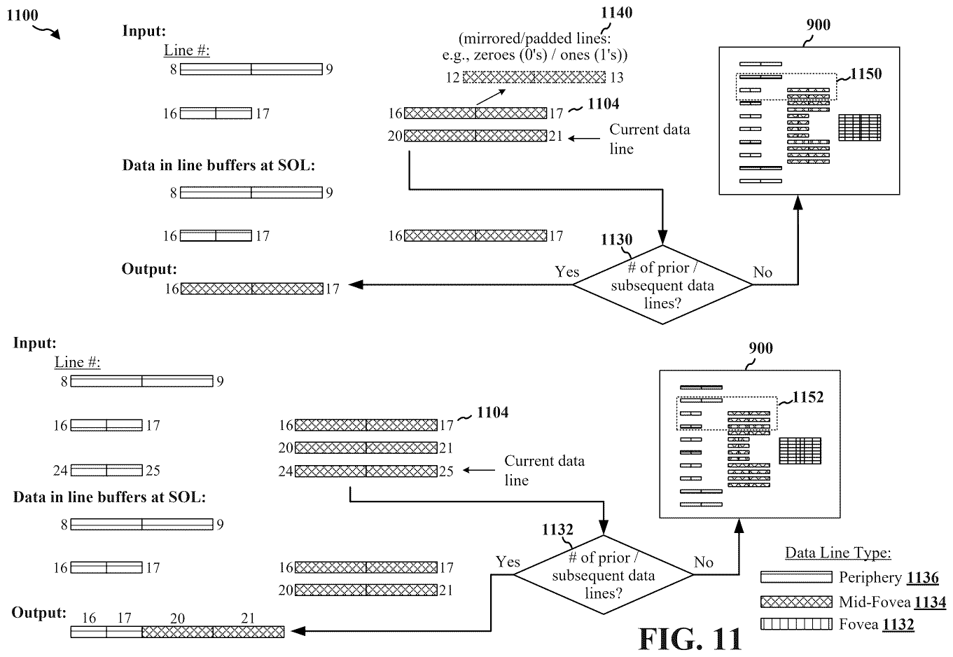

Examples of aspects for obtaining and outputting the data lines 932, the data lines 934, and the data lines 934 are described below in FIGS. 10, 11.

FIG. 10 illustrates a diagram 1000 of an example of memory area reduction for foveation via compute gating in accordance with one or more techniques of this disclosure. Diagram 1000 is described with reference to diagram 900 in FIG. 9, and in the context of a 5×5 kernel with data lines 1032 for a fovea region, data lines 1034 for a gated mid-fovea region, and data lines 1036 for a gated periphery region. As described herein, e.g., for an N×N kernel, for context associated with an FOV, a number of prior data lines and a number of subsequent data lines may be utilized for context in processing of a given data line.

Referring also to diagram 900, and to input data lines (a set of data lines 1050 in diagram 1000), data line 0 and data line 1 of the data lines 1036 may be present in a buffer of a contiguous portion of memory associated with a gated periphery region at a start of line (SOL) for the contiguous portion of memory. Data line 0 and data line 1 of data lines 1036 may be initial data lines 1002 for the gated periphery region. Aspects herein provide for mirrored or padded data lines, such as mirrored lines 1040 (e.g., as zeros or ones), to represent a number of prior data lines with respect to initial data lines, e.g., the initial data lines 1002. Aspects herein provide for mirrored lines 1040 (e.g., as zeros or ones) to be stored in the contiguous portion of memory, while in other aspects the mirrored lines 1040 may be utilized but may remain unstored, and to represent a number of prior data lines with respect to initial data lines, e.g., the initial data lines 1002. When a current data line (e.g., data line 8 and data line 9 associated with the gated periphery region) is obtained for the contiguous portion of memory, and when including the mirrored lines 1040 for a 5×5 kernel, it may be determined (at 1030) for the set of data lines 1050 if the initial data lines 1002, e.g., the data line 0 and data line 1 of data lines 1036, have a number (e.g., 2: the mirrored lines 1040) of prior data lines and have a number (e.g., 2: data line 8 and data line 9) of subsequent data lines present in the contiguous portion of memory. If so, the data line 0 and the data line 1 may be output from the contiguous portion of memory; if not, operation may return to obtain a new current data line as an input to the contiguous portion of memory.

Referring again to diagram 900, and also to later input data lines (a set of data lines 1052 in diagram 1000), data line 0, data line 1, data line 8, and data line 9 of the data lines 1036 may be present in the buffer of the contiguous portion of memory associated with a gated periphery region at a SOL for the contiguous portion of memory, and data line 16 and data line 17 of the data lines 1034 associated with the gated mid-fovea region, as well as data line 16 and data line 17 of the data lines 1034 associated with a gated mid-fovea region (e.g., initial data lines 1004 of the data lines 1034), may be obtained as a current data line for the contiguous portion of memory. When this current data line is obtained for the contiguous portion of memory, it may be determined (at 1032) for the set of data lines 1052, in the periphery context for the 5×5 kernel, if data lines have a number (e.g., 2) of prior data lines and have a number (e.g., 2) of subsequent data lines present in the contiguous portion of memory. If so, such a data line may be output from the contiguous portion of memory; if not, operation may return to obtain a new current data line as an input to the contiguous portion of memory. In the illustrated example for the set of data lines 1052, line 8 and line 9 of the data lines 1036 (e.g., the periphery FOV/context) have a number (e.g., 2: line 0 and line 1 of the data lines 1036) of prior data lines and have a number (e.g., 2: line 16 and line 17 of the data lines 1036) of subsequent data lines present in the contiguous portion of memory, and line 8 and line 9 of the data lines 1036 are output from the contiguous portion of memory. For the set of data lines 1052, line 16 and line 17 of the data lines 1034 (e.g., the mid-fovea FOV/context) do not have a number (e.g., 2) of prior data lines and do not have a number (e.g., 2) of subsequent data lines of the data lines 1034 present in the contiguous portion of memory, and therefore, line 16 and line 17 of the data lines 1034 are not output from the contiguous portion of memory and a next current line is obtained.

FIG. 11 illustrates a diagram 1100 of an example of memory area reduction for foveation via compute gating in accordance with one or more techniques of this disclosure. Diagram 1100 is described with reference to diagram 900 in FIG. 9, as well as in the context of a 5×5 kernel with data lines 1132 for a fovea region, data lines 1134 for a gated mid-fovea region, and data lines 1136 for a gated periphery region. Diagram 1100 may be a continuing aspect of diagram 1000 in FIG. 10. As described herein, e.g., for an N×N kernel, for context associated with an FOV, a number of prior data lines and a number of subsequent data lines may be utilized for context in processing of a given data line.

Referring also to diagram 900, and to input data lines (a set of data lines 1150 in diagram 1100), data line 8, data line 9, data line 16, and data line 17 of the data lines 1136 may be present in a buffer of a contiguous portion of memory associated with a gated periphery region, and data line 16 and data line 17 of the data lines 1134 may be present in a buffer of the contiguous portion of memory associated with a gated mid-fovea region, at a SOL for the contiguous portion of memory. Data line 16 and data line 17 of the data lines 1134 may be initial data lines 1104 for the gated mid-fovea region. Aspects herein provide for mirrored lines 1140 (e.g., as zeros or ones) to represent a number of prior data lines with respect to initial data lines, e.g., the initial data lines 1104. Aspects herein provide for mirrored lines 1140 (e.g., as zeros or ones) to be stored in the contiguous portion of memory and to represent a number of prior data lines with respect to initial data lines, e.g., the initial data lines 1104. When a current data line (e.g., data line 20 and data line 21 associated with the gated mid-fovea region) is obtained for the contiguous portion of memory, and when including the mirrored lines 1140 for a 5×5 kernel, it may be determined (at 1130) for the set of data lines 1150 if the initial data lines 1104, e.g., the data line 16 and data line 17 of data lines have a number (e.g., 2: the mirrored lines 1140) of prior data lines and have a number (e.g., 2: data line 20 and data line 21) of subsequent data lines present in the contiguous portion of memory for the same FOV (e.g., the data lines 1134). If so, the data line 16 and the data line 17 may be output from the contiguous portion of memory; if not, operation may return to obtain a new current data line as an input to the contiguous portion of memory. Additionally, as data line 16 and data line 17 of the data lines 1136 do not have the threshold number of subsequent data lines in the set of data lines 1150 for the periphery FOV, and so with respect to the data lines 1136, a next current line will be obtained for the contiguous portion of memory.

Referring again to diagram 900, and also to later input data lines (a set of data lines 1152 in diagram 1100), data line 8, data line 9, data line 16, and data line 17 of the data lines 1136 may be present in a buffer of the contiguous portion of memory associated with a gated periphery region, and data line 16, data line 17, data line 20, and data line 21 of the data lines 1134 may be present in a buffer of the contiguous portion of memory associated with the gated mid-fovea region, at a SOL for the contiguous portion of memory. Data line 24 and data line 25 of the data lines 1136, as well as data line 24 and data line 25 of the data lines 1134 associated with a gated mid-fovea region, may be obtained as a current data line for the contiguous portion of memory. When this current data line is obtained for the contiguous portion of memory, it may be determined (at 1132) for the set of data lines 1152, in the periphery context and/or the mid-fovea context for the 5×5 kernel, if data lines have a number (e.g., 2) of prior data lines and have a number (e.g., 2) of subsequent data lines present in the contiguous portion of memory. If so, such a data line may be output from the contiguous portion of memory; if not, operation may return to obtain a new current data line as an input to the contiguous portion of memory. In the illustrated example for the set of data lines 1152, data line 16 and data line 17 of the data lines 1136 (e.g., the periphery FOV/context) have a number (e.g., 2: data line 8 and data line 9 of the data lines 1136) of prior data lines and have a number (e.g., 2: data line 24 and data line 25 of the data lines 1136) of subsequent data lines present in the contiguous portion of memory, and data line 16 and data line 17 of the data lines 1136 are output from the contiguous portion of memory. For the set of data lines 1152, data line 20 and data line 21 of the data lines 1134 (e.g., the mid-fovea FOV/context) have a number (e.g., 2) of prior data lines and have a number (e.g., 2) of subsequent data lines of the data lines 1134 present in the contiguous portion of memory, and therefore, data line 20 and data line 21 of the data lines 1134 (e.g., the periphery FOV/context) may also be output from the contiguous portion of memory as these lines also have a number (e.g., 2: data line 16 and data line 17 of the data lines 1134) of prior data lines and have a number (e.g., 2: data line 24 and data line 25 of the data lines 1134) of subsequent data lines present in the contiguous portion of memory.

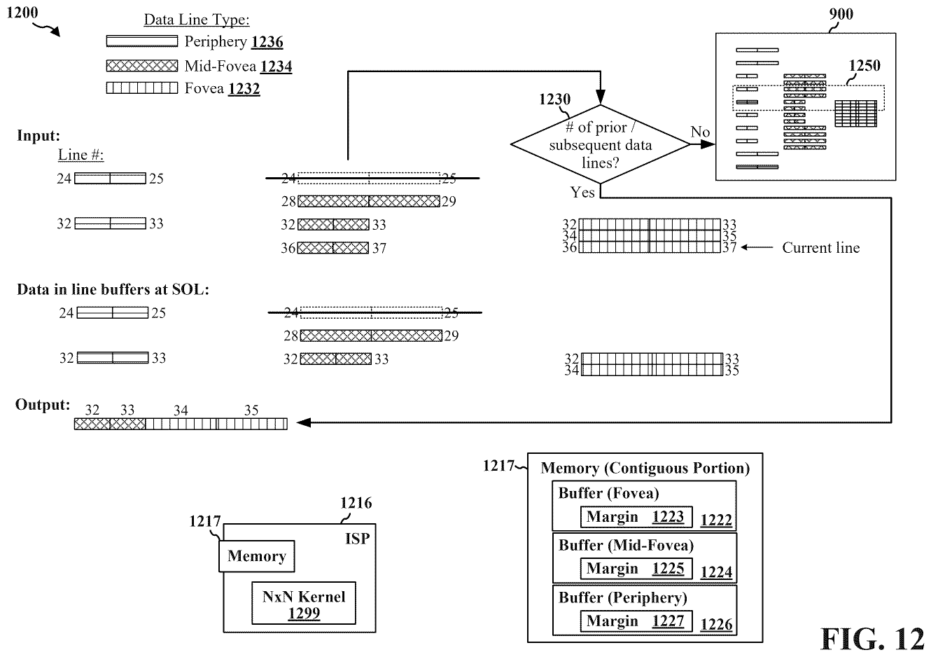

FIG. 12 illustrates a diagram 1200 of an example of memory area reduction for foveation via compute gating in accordance with one or more techniques of this disclosure. Diagram 1200 is described with reference to diagram 900 in FIG. 9, as well as in the context of a 5×5 kernel with data lines 1232 for a fovea region, data lines 1234 for a gated mid-fovea region, and data lines 1236 for a gated periphery region. Diagram 1200 may be a continuing aspect of diagram 1100 in FIG. 11. As described herein, e.g., for an N×N kernel, for context associated with an FOV, a number of prior data lines and a number of subsequent data lines may be utilized for context in processing of a given data line.

Referring also to diagram 900, and also to later input data lines (a set of data lines 1250 in diagram 1200), data line 24, data line 25, data line 32, and data line 33 of the data lines 1236 may be present in a buffer of the contiguous portion of memory associated with the gated periphery region, data line 28, data line 29, data line 32, and data line 33 of the data lines 1234 may be present in a buffer of the contiguous portion of memory associated with the gated mid-fovea region, and data line 32, data line 33, data line 34, and data line 35 of the data lines 1234 may be present in a buffer of the contiguous portion of memory associated with the fovea region, at a SOL for the contiguous portion of memory. Data line 24 and data line 25 of the data lines 1234 associated with a gated mid-fovea region may be last output from the contiguous portion of memory, as described herein. Data line 36 and data line 37 of the data lines 1234 associated with the gated mid-fovea region, as well as data line 36 and data line 37 of the data lines 1232 associated with the fovea region, may be obtained as a current data line for the contiguous portion of memory.

When this current data line is obtained for the contiguous portion of memory, it may be determined (at 1230) for the set of data lines 1250, in the periphery context, the mid-fovea context, and/or the fovea context for the 5×5 kernel, if data lines have a number (e.g., 2) of prior data lines and have a number (e.g., 2) of subsequent data lines present in the contiguous portion of memory for a given context. If so, such a data line may be output from the contiguous portion of memory; if not, operation may return to obtain a new current data line as an input to the contiguous portion of memory. In the illustrated example for the set of data lines 1250, data line 32 and data line 33 of the data lines 1234 (e.g., the mid-fovea FOV/context) have a number (e.g., 2: data line 28 and data line 29 of the data lines 1234) of prior data lines and have a number (e.g., 2: data line 36 and data line 37 of the data lines 1234) of subsequent data lines present in the contiguous portion of memory, and data line 32 and data line 33 of the data lines 1234 are output from the contiguous portion of memory. For the set of data lines 1250, data line 34 and data line 35 of the data lines 1232 (e.g., the fovea FOV/context) have a number (e.g., 2: data line 32 and data line 33) of prior data lines and have a number (e.g., 2: data line 36 and data line 37) of subsequent data lines of the data lines 1232 present in the contiguous portion of memory, and therefore, data line 34 and data line 35 of the data lines 1232 (e.g., the fovea FOV/context) may also be output from the contiguous portion of memory.

Diagram 1200 also shows an example of a N×N kernel 1299 associated with an ISP 1216 and a contiguous portion of memory 1217. The N×N kernel 1299 may be a 3×3 kernel, a 5×5 kernel, a 7×7 kernel, and/or the like in aspects. Diagram 1200 additionally shows an example of margin areas for buffers of the contiguous memory 1217. In aspects, the contiguous portion of memory 1217 may include buffers for data lines of each FOV associated with gated foveation. For example, the contiguous portion of memory 1217 may include a buffer 1226 that corresponds to data lines for a gated periphery region (e.g., a first FOV), a buffer 1222 that corresponds to data lines for a fovea region (e.g., a second FOV), and buffer 1224 that corresponds to data lines for a gated mid-fovea region 804 (e.g., a third FOV). A margin area 1227, a margin area 1223, and a margin area 1225 may respectively include an area for at least one additional line for a corresponding context or FOV. A margin area herein may be based on context timing stagger (e.g., the timing 990 for ISP input in FIG. 9) of data lines for at least one of the first FOV or context, the second FOV or context, and/or the third FOV or context. The area of a margin herein may be greater than a minimum area for pixel data of a first set of data lines, as described, by a size of the margin area.

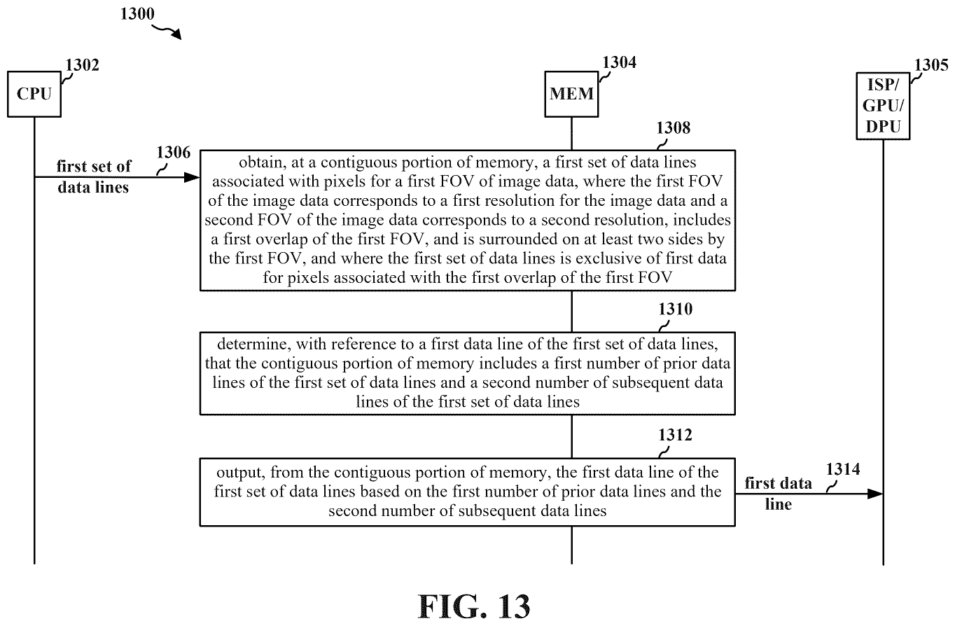

FIG. 13 is a call flow diagram 1300 illustrating example communications between a data processor 1302 and a contiguous portion of memory 1304 in accordance with one or more techniques of this disclosure. In aspects, call flow diagram 1300 is described for memory area reduction for foveation via compute gating. In an example, the data processor 1302 may be or include the processing unit 120/the compute gating controller 198, a CPU (e.g., as illustrated by way of example), a GPU, and/or the like. In aspects, as shown, an ISP/GPU/DPU 1305 may also communicate with the contiguous portion of memory 1304 (e.g., to receive outputs thereof). In aspects, the contiguous portion of memory 1304 may perform the described operations in conjunction with the data processor 1302 and/or a controller thereof. In the context of the call flow diagram 1300, a first FOV may correspond to a periphery FOV, a second FOV may correspond to a fovea FOV, and a third FOV may correspond to a mid-fovea FOV. In aspects, the data processor 1302 and/or the contiguous portion of memory 1304 may comprise a wireless communication device that is configured to perform the call flow diagram 1300.

At 1308, the contiguous portion of memory 1304 may obtain a first set of data lines 1306 associated with first pixels for a first FOV of image data. The first FOV of the image data may correspond to a first resolution for the image data (e.g., for a periphery FOV or region). A second FOV of the image data may correspond to a second resolution (e.g., for a fovea FOV or region), e.g., different than the first resolution. The second FOV may include a first overlap of the first FOV and may be surrounded by the first FOV. In aspects, first data for pixels associated with the first overlap of the first FOV may be outside of the first set of data lines 1306 (e.g., is excluded from the first set of data lines 1306 and not stored at the contiguous portion of memory 1304). In aspects, to obtain (at 1308) the first set of data lines 1306 associated with the first pixels for the first FOV of image data, the contiguous portion of memory 1304 may be configured to store the first set of data lines 1306 associated with the first pixels for the first FOV of image data, and to refrain from storing the first data for pixels associated with the first overlap of the first FOV. In some aspects, to obtain the first set of data lines 1306, the contiguous portion of memory 1304 may be configured to receive the first set of data lines 1306 from the data processor 1302, from a VST sensor, and/or from a foveated sensor.

At 1310, the contiguous portion of memory 1304 may determine, with reference to a first data line 1314 of the first set of data lines 1306, that the contiguous portion of memory 1304 includes a first number of prior data lines of the first set of data lines 1306 and a second number of subsequent data lines of the first set of data lines 1306. In aspects, the first number of prior data lines may be prior to the second number of subsequent data lines in the first set of data lines 1306. In some aspects, the first set of data lines 1306 may include initial data lines for the first FOV of the image data and the number of prior data lines may be zero. In such aspects, the prior data lines may be first mirrored data lines of the first set of data lines 1306 or may be first padded data lines of a default data value (e.g., zeroes (0's) or ones (1's)). In some aspects, the first set of data lines 1306 may include final data lines for the first FOV of the image data and the number of subsequent data lines may be zero. In such aspects, the subsequent data lines may be second mirrored data lines of the first set of data lines 1306 or may be second padded data lines of a default data value (e.g., zeroes (0's) or ones (1's)).

At 1312, the contiguous portion of memory 1304 may output the first data line 1314 of the first set of data lines 1306 based on the first number of prior data lines and the second number of subsequent data lines. In aspects, to output the first data line 1314 based on the first number of prior data lines and the second number of subsequent data lines, the contiguous portion of memory 1304 may be configured to provide the first data line 1314 for processing by at least one of an ISP, a graphics processor, or a display processor (e.g., the ISP/GPU/DPU 1305) and/or may be configured to provide the first data line 1314 to a display panel or a HMD.

In aspects, the contiguous portion of memory 1304 may obtain, after the first set of data lines 1306, a second set of data lines associated with second pixels for the second FOV of the image data. The contiguous portion of memory 1304 may determine, with reference to a second data line of the second set of data lines, that the contiguous portion of memory 1304 includes a third number of prior data lines of the second set of data lines and a fourth number of subsequent data lines of the second set of data lines. The contiguous portion of memory 1304 may output the second data line of the second set of data lines based on the third number of prior data lines and the fourth number of subsequent data lines. In aspects, to output the second data line, the contiguous portion of memory 1304 may be configured to provide the second data line for processing by at least one of an ISP, a graphics processor, or a display processor (e.g., the ISP/GPU/DPU 1305) and/or may be configured to provide the second data line to a display panel or a HMD.

In aspects, the contiguous portion of memory 1304 may obtain, before the second set of data lines and after the first set of data lines 1306, a third set of data lines associated with third pixels for a third FOV of the image data. In aspects, the third FOV of the image data may correspond to a third resolution for the image data, and the third FOV may include a second overlap of the first FOV and may be surrounded on at least two third FOV sides by the first FOV. In aspects, the second FOV may be surrounded on at least two second FOV sides by the third FOV and may include a third overlap of the third FOV. In aspects, the first set of data lines 1306 may be exclusive of second data for pixels associated with the second overlap of the first FOV, and the third set of data lines may be exclusive of third data for pixels associated with the third overlap of the third FOV. That is, pixel data associated with overlapping FOVs may not be stored at the contiguous portion of memory 1304. In aspects, the contiguous portion of memory 1304 may determine, with reference to a third data line of the third set of data lines, that the contiguous portion of memory 1304 include a fifth number of prior data lines of the third set of data lines and a sixth number of subsequent data lines of the third set of data lines, and the fifth number of prior data lines may be prior to the sixth number of subsequent data lines in the third set of data lines. In aspects, the contiguous portion of memory 1304 may output the third data line of the third set of data lines based on the fifth number of prior data lines and the sixth number of subsequent data lines. In aspects, to output the third data line, the contiguous portion of memory 1304 may be configured to provide the third data line for processing by at least one of an ISP, a graphics processor, or a display processor (e.g., the ISP/GPU/DPU 1305) and/or may be configured to provide the third data line to a display panel or a HMD.

In some aspects, the contiguous portion of memory 1304 may be configured to output any combination of the first data line 1314, the second data line, or the third data line concurrently or at least partially concurrently.

In aspects, the first number of prior data lines, the third number of prior data lines, the fifth number of prior data lines, the second number of subsequent data lines, the fourth number of subsequent data lines, and the sixth number of subsequent data lines may be based on a data line configuration of a kernel associated with an ISP and the contiguous portion of memory 1304.

In aspects, contiguous portion of memory 1304 may include a first buffer that corresponds to the first FOV, a second buffer that corresponds to the second FOV and is separate from the first buffer, and a third buffer that corresponds to the third FOV and is separate from both of the first buffer and the second buffer. At least one of the first buffer or the third buffer may have an area (e.g., a size), based on compute gating (which may be associated with regions of the image data), that is less than a maximum area for total pixel data that corresponds to the first FOV for the first set of data lines 1306 or the third FOV for the third set of data lines, respectively. In some aspects, the area may include a margin area, and the margin area may be based on a context timing stagger of data lines for at least one of the first FOV, the second FOV, or the third FOV. The margin area may correspond to at least one additional data line associated with the first set of data lines 1306, the second set of data lines, or the third set of data lines, and the area may be greater than a minimum area for pixel data of the first set of data lines 1306, the second set of data lines, or the third set of data lines by a size of the margin area.

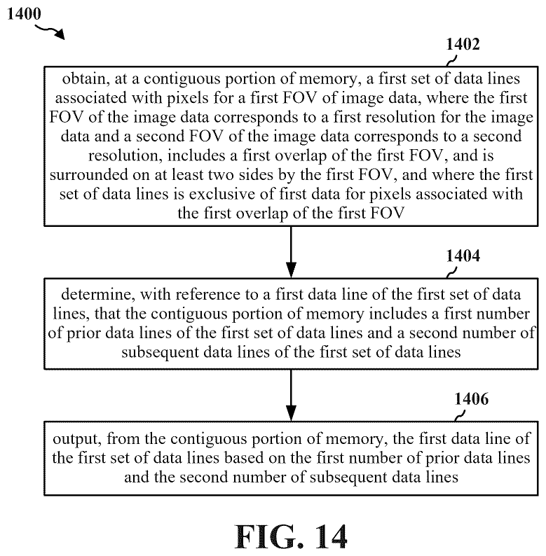

FIG. 14 is a flowchart 1400 of an example method of data or graphics processing in accordance with one or more techniques of this disclosure. The method may be for memory area reduction for foveation, e.g., via compute gating. The method may be performed by an apparatus, such as an apparatus for data or graphics processing, a GPU, a CPU, a wireless communication device, and the like, as used in connection with the aspects of FIGS. 1-13.

At 1402, the apparatus obtain, at a contiguous portion of memory, a first set of data lines associated with first pixels for a first FOV of image data, where the first FOV of the image data corresponds to a first resolution for the image data and a second FOV of the image data corresponds to a second resolution, includes a first overlap of the first FOV, and is surrounded on at least two second FOV sides by the first FOV, and where the first set of data lines is exclusive of first data for pixels associated with the first overlap of the first FOV. For example, referring to FIG. 13, at 1308, the contiguous portion of memory 1304 (e.g., 817 in FIG. 8; 917 in FIG. 9; 1217 in FIG. 12) may obtain a first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) associated with first pixels for a first FOV (e.g., 606 in FIG. 6; 706 in FIG. 7; 806 in FIG. 8; 906 in FIG. 9) of image data (e.g., 598 in FIG. 5; 898 in FIG. 8). The first FOV (e.g., 606 in FIG. 6; 706 in FIG. 7; 806 in FIG. 8; 906 in FIG. 9) of the image data (e.g., 598 in FIG. 5; 898 in FIG. 8) may correspond to a first resolution (e.g., 4:1 in FIG. 5) for the image data (e.g., 598 in FIG. 5; 898 in FIG. 8) (e.g., for a periphery FOV or region (e.g., 606 in FIG. 6; 706 in FIG. 7; 806 in FIG. 8; 906 in FIG. 9)). A second FOV (e.g., 602 in FIG. 6; 702 in FIG. 7; 802 in FIG. 8; 902 in FIG. 9) of the image data (e.g., 598 in FIG. 5; 898 in FIG. 8) may correspond to a second resolution (e.g., 1:1 in FIG. 5) (e.g., for a fovea FOV or region (e.g., 602 in FIG. 6; 702 in FIG. 7; 802 in FIG. 8; 902 in FIG. 9)), e.g., different than the first resolution (e.g., 4:1 in FIG. 5). The second FOV (e.g., 602 in FIG. 6; 702 in FIG. 7; 802 in FIG. 8; 902 in FIG. 9) may include a first overlap (e.g., 708, 710 in FIG. 7; 808, 810 in FIG. 8; 908, 910 in FIG. 9) of the first FOV (e.g., 606 in FIG. 6; 706 in FIG. 7; 806 in FIG. 8; 906 in FIG. 9) and may be surrounded on at least two second FOV sides by the first FOV (e.g., 606 in FIG. 6; 706 in FIG. 7; 806 in FIG. 8; 906 in FIG. 9). In aspects, first data for pixels associated with the first overlap (e.g., 708, 710 in FIG. 7; 808, 810 in FIG. 8; 908, 910 in FIG. 9) of the first FOV (e.g., 606 in FIG. 6; 706 in FIG. 7; 806 in FIG. 8; 906 in FIG. 9) may be outside of the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) (e.g., is excluded from the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) and not stored at the contiguous portion of memory 1304 (e.g., 817 in FIG. 8; 917 in FIG. 9; 1217 in FIG. 12)). In aspects, to obtain (at 1308) the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) associated with the first pixels for the first FOV (e.g., 606 in FIG. 6; 706 in FIG. 7; 806 in FIG. 8; 906 in FIG. 9) of image data (e.g., 598 in FIG. 5; 898 in FIG. 8), the contiguous portion of memory 1304 (e.g., 817 in FIG. 8; 917 in FIG. 9; 1217 in FIG. 12) may be configured to store the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) associated with the first pixels for the first FOV (e.g., 606 in FIG. 6; 706 in FIG. 7; 806 in FIG. 8; 906 in FIG. 9) of image data (e.g., 598 in FIG. 5; 898 in FIG. 8), and to refrain from storing the first data for pixels associated with the first overlap (e.g., 708, 710 in FIG. 7; 808, 810 in FIG. 8; 908, 910 in FIG. 9) of the first FOV (e.g., 606 in FIG. 6; 706 in FIG. 7; 806 in FIG. 8; 906 in FIG. 9). In some aspects, to obtain the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12), the contiguous portion of memory 1304 (e.g., 817 in FIG. 8; 917 in FIG. 9; 1217 in FIG. 12) may be configured to receive the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) from the data processor 1302, from a VST sensor, and/or from a foveated sensor. In an example, 1402 may be performed by the compute gating controller 198.

At 1404, the apparatus may determine, with reference to a first data line of the first set of data lines, that the contiguous portion of memory includes a first number of prior data lines of the first set of data lines and a second number of subsequent data lines of the first set of data lines. For example, referring to FIG. 13, at 1310, the contiguous portion of memory 1304 (e.g., 817 in FIG. 8; 917 in FIG. 9; 1217 in FIG. 12) may determine (e.g., at 1030, at 1032 in FIG. 10; at 1130, at 1132 in FIG. 11; at 1230 in FIG. 12), with reference to a first data line 1314 (e.g., lines 0/1, lines 8/9 in FIG. 10; lines 16/17 in FIG. 11; lines 32/33, lines 34/35 in FIG. 12) of the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12), that the contiguous portion of memory 1304 (e.g., 817 in FIG. 8; 917 in FIG. 9; 1217 in FIG. 12) includes a first number of prior data lines (e.g., lines-2/-1, lines 0/1 in FIG. 10; lines 12/13, lines 16/17 in FIG. 11; lines 24/25, lines 28/29 in FIG. 12) of the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) and a second number of subsequent data lines (e.g., lines 8/9, lines 16/17 in FIG. 10; lines 20/21, lines 24/26 in FIG. 11; lines 36/37 in FIG. 12) of the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12). In aspects, the first number of prior data lines (e.g., lines-2/-1, lines 0/1 in FIG. 10; lines 12/13, lines 16/17 in FIG. 11; lines 24/25, lines 28/29 in FIG. 12) may be prior to the second number of subsequent data lines (e.g., lines 8/9, lines 16/17 in FIG. 10; lines 20/21, lines 24/26 in FIG. 11; lines 36/37 in FIG. 12) in the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12). In some aspects, the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) may include initial data lines (e.g., 1002 in FIG. 10; 1104 in FIG. 11) for the first FOV (e.g., 606 in FIG. 6; 706 in FIG. 7; 806 in FIG. 8; 906 in FIG. 9) of the image data (e.g., 598 in FIG. 5; 898 in FIG. 8) and the number of prior data lines may be zero. In such aspects, the prior data lines may be first mirrored data lines (e.g., 1040 in FIG. 10; 1140 in FIG. 11) of the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) or may be first padded data lines (e.g., 1040 in FIG. 10; 1140 in FIG. 11) of a default data value (e.g., zeroes (0's) or ones (1's)). In some aspects, the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) may include final data lines for the first FOV (e.g., 606 in FIG. 6; 706 in FIG. 7; 806 in FIG. 8; 906 in FIG. 9) of the image data (e.g., 598 in FIG. 5; 898 in FIG. 8) and the number of subsequent data lines may be zero. In such aspects, the subsequent data lines may be second mirrored data lines of the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) or may be second padded data lines of a default data value (e.g., zeroes (0's) or ones (1's)). In an example, 1404 may be performed by the compute gating controller 198.

At 1406, the apparatus may output, from the contiguous portion of memory, the first data line of the first set of data lines based on the first number of prior data lines and the second number of subsequent data lines. For example, referring to FIG. 13, at 1312, the contiguous portion of memory 1304 (e.g., 817 in FIG. 8; 917 in FIG. 9; 1217 in FIG. 12) may output (e.g., 818 in FIG. 8) the first data line 1314 (e.g., lines 0/1, lines 8/9 in FIG. 10; lines 16/17 in FIG. 11; lines 32/33, lines 34/35 in FIG. 12) of the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) based on the first number of prior data lines (e.g., lines-2/-1, lines 0/1 in FIG. 10; lines 12/13, lines 16/17 in FIG. 11; lines 24/25, lines 28/29 in FIG. 12) and the second number of subsequent data lines (e.g., lines 8/9, lines 16/17 in FIG. 10; lines 20/21, lines 24/26 in FIG. 11; lines 36/37 in FIG. 12). In aspects, to output (e.g., 818 in FIG. 8) the first data line 1314 (e.g., lines 0/1, lines 8/9 in FIG. 10; lines 16/17 in FIG. 11; lines 32/33, lines 34/35 in FIG. 12) based on the first number of prior data lines (e.g., lines-2/-1, lines 0/1 in FIG. 10; lines 12/13, lines 16/17 in FIG. 11; lines 24/25, lines 28/29 in FIG. 12) and the second number of subsequent data lines (e.g., lines 8/9, lines 16/17 in FIG. 10; lines 20/21, lines 24/26 in FIG. 11; lines 36/37 in FIG. 12), the contiguous portion of memory 1304 (e.g., 817 in FIG. 8; 917 in FIG. 9; 1217 in FIG. 12) may be configured to provide the first data line 1314 (e.g., lines 0/1, lines 8/9 in FIG. 10; lines 16/17 in FIG. 11; lines 32/33, lines 34/35 in FIG. 12) for processing by at least one of an ISP (e.g., 816 in FIG. 8; 1216 in FIG. 12), a graphics processor, or a display processor (e.g., the ISP/GPU/DPU 1305) and/or may be configured to provide the first data line 1314 (e.g., lines 0/1, lines 8/9 in FIG. 10; lines 16/17 in FIG. 11; lines 32/33, lines 34/35 in FIG. 12) to a display panel or a HMD (e.g., 512 in FIG. 5).

In aspects, the contiguous portion of memory 1304 (e.g., 817 in FIG. 8; 917 in FIG. 9; 1217 in FIG. 12) may obtain, after the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12), a second set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12) associated with second pixels for the second FOV (e.g., 602 in FIG. 6; 702 in FIG. 7; 802 in FIG. 8; 902 in FIG. 9) of the image data (e.g., 598 in FIG. 5; 898 in FIG. 8). The contiguous portion of memory 1304 (e.g., 817 in FIG. 8; 917 in FIG. 9; 1217 in FIG. 12) may determine (e.g., at 1030, at 1032 in FIG. 10; at 1130, at 1132 in FIG. 11; at 1230 in FIG. 12), with reference to a second data line (e.g., lines 0/1, lines 8/9 in FIG. 10; lines 16/17 in FIG. 11; lines 32/33, lines 34/35 in FIG. 12) of the second set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12), that the contiguous portion of memory 1304 (e.g., 817 in FIG. 8; 917 in FIG. 9; 1217 in FIG. 12) includes a third number of prior data lines (e.g., lines-2/-1, lines 0/1 in FIG. 10; lines 12/13, lines 16/17 in FIG. 11; lines 24/25, lines 28/29 in FIG. 12) of the second set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12) and a fourth number of subsequent data lines (e.g., lines 8/9, lines 16/17 in FIG. 10; lines 20/21, lines 24/26 in FIG. 11; lines 36/37 in FIG. 12) of the second set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12). The contiguous portion of memory 1304 (e.g., 817 in FIG. 8; 917 in FIG. 9; 1217 in FIG. 12) may output (e.g., 818 in FIG. 8) the second data line (e.g., lines 0/1, lines 8/9 in FIG. 10; lines 16/17 in FIG. 11; lines 32/33, lines 34/35 in FIG. 12) of the second set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12) based on the third number of prior data lines (e.g., lines-2/-1, lines 0/1 in FIG. 10; lines 12/13, lines 16/17 in FIG. 11; lines 24/25, lines 28/29 in FIG. 12) and the fourth number of subsequent data lines (e.g., lines 8/9, lines 16/17 in FIG. 10; lines 20/21, lines 24/26 in FIG. 11; lines 36/37 in FIG. 12). In aspects, to output (e.g., 818 in FIG. 8) the second data line (e.g., lines 0/1, lines 8/9 in FIG. 10; lines 16/17 in FIG. 11; lines 32/33, lines 34/35 in FIG. 12), the contiguous portion of memory 1304 (e.g., 817 in FIG. 8; 917 in FIG. 9; 1217 in FIG. 12) may be configured to provide the second data line (e.g., lines 0/1, lines 8/9 in FIG. 10; lines 16/17 in FIG. 11; lines 32/33, lines 34/35 in FIG. 12) for processing by at least one of an ISP (e.g., 816 in FIG. 8; 1216 in FIG. 12), a graphics processor, or a display processor (e.g., the ISP/GPU/DPU 1305) and/or may be configured to provide the second data line (e.g., lines 0/1, lines 8/9 in FIG. 10; lines 16/17 in FIG. 11; lines 32/33, lines 34/35 in FIG. 12) to a display panel or a HMD (e.g., 512 in FIG. 5).

In aspects, the contiguous portion of memory 1304 (e.g., 817 in FIG. 8; 917 in FIG. 9; 1217 in FIG. 12) may obtain, before the second set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12) and after the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12), a third set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12) associated with third pixels for a third FOV (e.g., 604 in FIG. 6; 704 in FIG. 7; 804 in FIG. 8; 904 in FIG. 9) of the image data (e.g., 598 in FIG. 5; 898 in FIG. 8). In aspects, the third FOV (e.g., 604 in FIG. 6; 704 in FIG. 7; 804 in FIG. 8; 904 in FIG. 9) of the image data (e.g., 598 in FIG. 5; 898 in FIG. 8) may correspond to a third resolution (e.g., 2:1 in FIG. 5) for the image data (e.g., 598 in FIG. 5; 898 in FIG. 8), and the third FOV (e.g., 604 in FIG. 6; 704 in FIG. 7; 804 in FIG. 8; 904 in FIG. 9) may include a second overlap (e.g., 708, 710 in FIG. 7; 808, 810 in FIG. 8; 908, 910 in FIG. 9) of the first FOV and may be surrounded on at least third FOV two sides by the first FOV (e.g., 606 in FIG. 6; 706 in FIG. 7; 806 in FIG. 8; 906 in FIG. 9). In aspects, the second FOV (e.g., 602 in FIG. 6; 702 in FIG. 7; 802 in FIG. 8; 902 in FIG. 9) may be surrounded on at least two second FOV sides by the third FOV (e.g., 604 in FIG. 6; 704 in FIG. 7; 804 in FIG. 8; 904 in FIG. 9) and may include a third overlap (e.g., 708, 710 in FIG. 7; 808, 810 in FIG. 8; 908, 910 in FIG. 9) of the third FOV (e.g., 604 in FIG. 6; 704 in FIG. 7; 804 in FIG. 8; 904 in FIG. 9). In aspects, the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) may be exclusive of second data for pixels (e.g., 714 in FIG. 7) associated with the second overlap (e.g., 708, 710 in FIG. 7; 808, 810 in FIG. 8; 908, 910 in FIG. 9) of the first FOV (e.g., 606 in FIG. 6; 706 in FIG. 7; 806 in FIG. 8; 906 in FIG. 9), and the third set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12) may be exclusive of third data for pixels (e.g., 714 in FIG. 7) associated with the third overlap (e.g., 708, 710 in FIG. 7; 808, 810 in FIG. 8; 908, 910 in FIG. 9) of the third FOV (e.g., 604 in FIG. 6; 704 in FIG. 7; 804 in FIG. 8; 904 in FIG. 9). That is, pixel data (e.g., 714 in FIG. 7) associated with overlapping FOVs may not be stored at the contiguous portion of memory 1304 (e.g., 817 in FIG. 8; 917 in FIG. 9; 1217 in FIG. 12). In aspects, the contiguous portion of memory 1304 (e.g., 817 in FIG. 8; 917 in FIG. 9; 1217 in FIG. 12) may determine (e.g., at 1030, at 1032 in FIG. 10; at 1130, at 1132 in FIG. 11; at 1230 in FIG. 12), with reference to a third data line (e.g., lines 0/1, lines 8/9 in FIG. 10; lines 16/17 in FIG. 11; lines 32/33, lines 34/35 in FIG. 12) of the third set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12), that the contiguous portion of memory 1304 (e.g., 817 in FIG. 8; 917 in FIG. 9; 1217 in FIG. 12) include a fifth number of prior data lines (e.g., lines-2/-1, lines 0/1 in FIG. 10; lines 12/13, lines 16/17 in FIG. 11; lines 24/25, lines 28/29 in FIG. 12) of the third set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12) and a sixth number of subsequent data lines (e.g., lines 8/9, lines 16/17 in FIG. 10; lines 20/21, lines 24/26 in FIG. 11; lines 36/37 in FIG. 12) of the third set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12), and the fifth number of prior data lines (e.g., lines-2/-1, lines 0/1 in FIG. 10; lines 12/13, lines 16/17 in FIG. 11; lines 24/25, lines 28/29 in FIG. 12) may be prior to the sixth number of subsequent data lines (e.g., lines 8/9, lines 16/17 in FIG. 10; lines 20/21, lines 24/26 in FIG. 11; lines 36/37 in FIG. 12) in the third set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12). In aspects, the contiguous portion of memory 1304 (e.g., 817 in FIG. 8; 917 in FIG. 9; 1217 in FIG. 12) may output (e.g., 818 in FIG. 8) the third data line (e.g., lines 0/1, lines 8/9 in FIG. 10; lines 16/17 in FIG. 11; lines 32/33, lines 34/35 in FIG. 12) of the third set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12) based on the fifth number of prior data lines (e.g., lines-2/-1, lines 0/1 in FIG. 10; lines 12/13, lines 16/17 in FIG. 11; lines 24/25, lines 28/29 in FIG. 12) and the sixth number of subsequent data lines (e.g., lines 8/9, lines 16/17 in FIG. 10; lines 20/21, lines 24/26 in FIG. 11; lines 36/37 in FIG. 12). In aspects, to output (e.g., 818 in FIG. 8) the third data line (e.g., lines 0/1, lines 8/9 in FIG. 10; lines 16/17 in FIG. 11; lines 32/33, lines 34/35 in FIG. 12), the contiguous portion of memory 1304 (e.g., 817 in FIG. 8; 917 in FIG. 9; 1217 in FIG. 12) may be configured to provide the third data line (e.g., lines 0/1, lines 8/9 in FIG. 10; lines 16/17 in FIG. 11; lines 32/33, lines 34/35 in FIG. 12) for processing by at least one of an ISP (e.g., 816 in FIG. 8; 1216 in FIG. 12), a graphics processor, or a display processor (e.g., the ISP/GPU/DPU 1305) and/or may be configured to provide the third data line (e.g., lines 0/1, lines 8/9 in FIG. 10; lines 16/17 in FIG. 11; lines 32/33, lines 34/35 in FIG. 12) to a display panel or a HMD (e.g., 512 in FIG. 5).

In some aspects, the contiguous portion of memory 1304 (e.g., 817 in FIG. 8; 917 in FIG. 9; 1217 in FIG. 12) may be configured to output (e.g., 818 in FIG. 8) any combination of the first data line 1314 (e.g., lines 0/1, lines 8/9 in FIG. 10; lines 16/17 in FIG. 11; lines 32/33, lines 34/35 in FIG. 12), the second data line (e.g., lines 0/1, lines 8/9 in FIG. 10; lines 16/17 in FIG. 11; lines 32/33, lines 34/35 in FIG. 12), or the third data line (e.g., lines 0/1, lines 8/9 in FIG. 10; lines 16/17 in FIG. 11; lines 32/33, lines 34/35 in FIG. 12) concurrently or at least partially concurrently.

In aspects, the first number of prior data lines (e.g., lines-2/-1, lines 0/1 in FIG. 10; lines 12/13, lines 16/17 in FIG. 11; lines 24/25, lines 28/29 in FIG. 12), the third number of prior data lines (e.g., lines-2/-1, lines 0/1 in FIG. 10; lines 12/13, lines 16/17 in FIG. 11; lines 24/25, lines 28/29 in FIG. 12), the fifth number of prior data lines (e.g., lines-2/-1, lines 0/1 in FIG. 10; lines 12/13, lines 16/17 in FIG. 11; lines 24/25, lines 28/29 in FIG. 12), the second number of subsequent data lines (e.g., lines 8/9, lines 16/17 in FIG. 10; lines 20/21, lines 24/26 in FIG. 11; lines 36/37 in FIG. 12), the fourth number of subsequent data lines (e.g., lines 8/9, lines 16/17 in FIG. 10; lines 20/21, lines 24/26 in FIG. 11; lines 36/37 in FIG. 12), and the sixth number of subsequent data lines (e.g., lines 8/9, lines 16/17 in FIG. 10; lines 20/21, lines 24/26 in FIG. 11; lines 36/37 in FIG. 12) may be based on a data line configuration of a kernel (e.g., 1299 in FIG. 12) associated with an ISP (e.g., 816 in FIG. 8; 1216 in FIG. 12) and the contiguous portion of memory 1304 (e.g., 817 in FIG. 8; 917 in FIG. 9; 1217 in FIG. 12).

In aspects, contiguous portion of memory 1304 (e.g., 817 in FIG. 8; 917 in FIG. 9; 1217 in FIG. 12) may include a first buffer (e.g., 826 in FIG. 8; 926 in FIG. 9; 1226 in FIG. 12) that corresponds to the first FOV (e.g., 606 in FIG. 6; 706 in FIG. 7; 806 in FIG. 8; 906 in FIG. 9), a second buffer (e.g., 822 in FIG. 8; 922 in FIG. 9; 1222 in FIG. 12) that corresponds to the second FOV (e.g., 602 in FIG. 6; 702 in FIG. 7; 802 in FIG. 8; 902 in FIG. 9) and is separate from the first buffer (e.g., 826 in FIG. 8; 926 in FIG. 9; 1226 in FIG. 12), and a third buffer (e.g., 824 in FIG. 8; 924 in FIG. 9; 1224 in FIG. 12) that corresponds to the third FOV (e.g., 604 in FIG. 6; 704 in FIG. 7; 804 in FIG. 8; 904 in FIG. 9) and is separate from both of the first buffer (e.g., 826 in FIG. 8; 926 in FIG. 9; 1226 in FIG. 12) and the second buffer (e.g., 822 in FIG. 8; 922 in FIG. 9; 1222 in FIG. 12). At least one of the first buffer (e.g., 826 in FIG. 8; 926 in FIG. 9; 1226 in FIG. 12) or the third buffer (e.g., 824 in FIG. 8; 924 in FIG. 9; 1224 in FIG. 12) may have an area (e.g., a size), based on compute gating (e.g., associated with regions of the image data (e.g., 598 in FIG. 5; 898 in FIG. 8)), that is less than a maximum area for total pixel data (e.g., 712 and 714 in FIG. 7) that corresponds to the first FOV (e.g., 606 in FIG. 6; 706 in FIG. 7; 806 in FIG. 8; 906 in FIG. 9) for the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) or the third FOV (e.g., 604 in FIG. 6; 704 in FIG. 7; 804 in FIG. 8; 904 in FIG. 9) for the third set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12), respectively. In some aspects, the area may include a margin area (e.g., 1223, 1225, 1227 in FIG. 12), and the margin area (e.g., 1223, 1225, 1227 in FIG. 12) may be based on a context timing stagger of data lines (e.g., lines 0/1, lines 8/9 in FIG. 10; lines 16/17 in FIG. 11; lines 32/33, lines 34/35 in FIG. 12) for at least one of the first FOV (e.g., 606 in FIG. 6; 706 in FIG. 7; 806 in FIG. 8; 906 in FIG. 9), the second FOV (e.g., 602 in FIG. 6; 702 in FIG. 7; 802 in FIG. 8; 902 in FIG. 9), or the third FOV (e.g., 604 in FIG. 6; 704 in FIG. 7; 804 in FIG. 8; 904 in FIG. 9). The margin area (e.g., 1223, 1225, 1227 in FIG. 12) may correspond to at least one additional data line (e.g., lines 0/1, lines 8/9 in FIG. 10; lines 16/17 in FIG. 11; lines 32/33, lines 34/35 in FIG. 12) associated with the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12), the second set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12), or the third set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12), and the area may be greater than a minimum area for pixel data of the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12), the second set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12), or the third set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12) by a size of the margin area (e.g., 1223, 1225, 1227 in FIG. 12). A first FOV may correspond to a periphery FOV (e.g., 606 in FIG. 6; 706 in FIG. 7; 806 in FIG. 8; 906 in FIG. 9), a second FOV may correspond to a fovea FOV (e.g., 602 in FIG. 6; 702 in FIG. 7; 802 in FIG. 8; 902 in FIG. 9), and a third FOV may correspond to a mid-fovea FOV (e.g., 604 in FIG. 6; 704 in FIG. 7; 804 in FIG. 8; 904 in FIG. 9). In an example, 1406 may be performed by the compute gating controller 198.

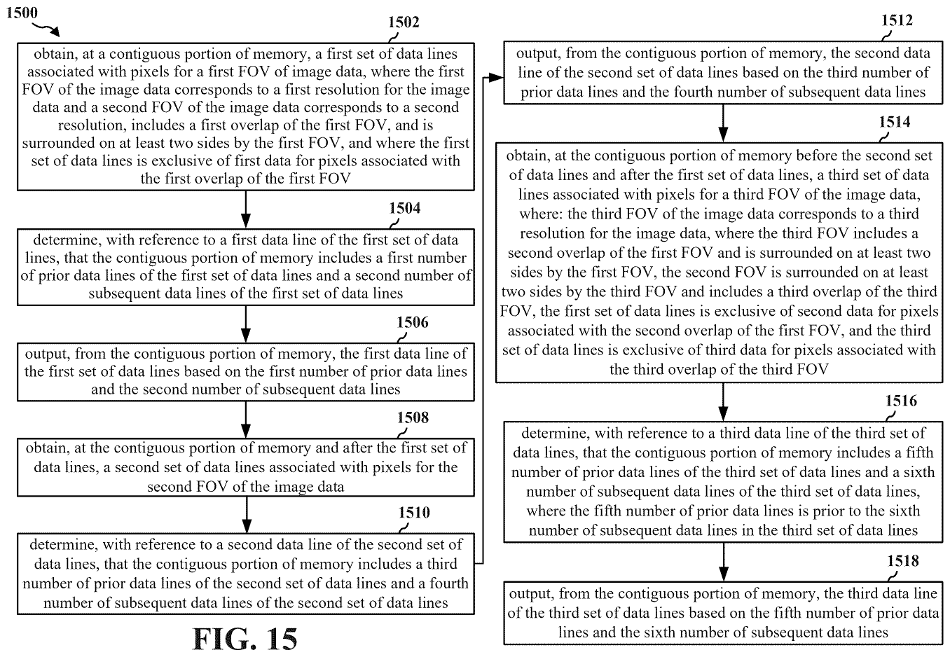

FIG. 15 is a flowchart 1500 of an example method of data or graphics processing in accordance with one or more techniques of this disclosure. The method may be for memory area reduction for foveation, e.g., via compute gating. The method may be performed by an apparatus, such as an apparatus for data or graphics processing, a GPU, a CPU, a wireless communication device, and the like, as used in connection with the aspects of FIGS. 1-13.

At 1502, the apparatus may obtain, at a contiguous portion of memory, a first set of data lines associated with first pixels for a first FOV of image data, where the first FOV of the image data corresponds to a first resolution for the image data and a second FOV of the image data corresponds to a second resolution, includes a first overlap of the first FOV, and is surrounded on at least two second FOV sides by the first FOV, and where the first set of data lines is exclusive of first data for pixels associated with the first overlap of the first FOV. For example, referring to FIG. 13, at 1308, the contiguous portion of memory 1304 (e.g., 817 in FIG. 8; 917 in FIG. 9; 1217 in FIG. 12) may obtain a first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) associated with first pixels for a first FOV (e.g., 606 in FIG. 6; 706 in FIG. 7; 806 in FIG. 8; 906 in FIG. 9) of image data (e.g., 598 in FIG. 5; 898 in FIG. 8). The first FOV (e.g., 606 in FIG. 6; 706 in FIG. 7; 806 in FIG. 8; 906 in FIG. 9) of the image data (e.g., 598 in FIG. 5; 898 in FIG. 8) may correspond to a first resolution (e.g., 4:1 in FIG. 5) for the image data (e.g., 598 in FIG. 5; 898 in FIG. 8) (e.g., for a periphery FOV or region (e.g., 606 in FIG. 6; 706 in FIG. 7; 806 in FIG. 8; 906 in FIG. 9)). A second FOV (e.g., 602 in FIG. 6; 702 in FIG. 7; 802 in FIG. 8; 902 in FIG. 9) of the image data (e.g., 598 in FIG. 5; 898 in FIG. 8) may correspond to a second resolution (e.g., 1:1 in FIG. 5) (e.g., for a fovea FOV or region (e.g., 602 in FIG. 6; 702 in FIG. 7; 802 in FIG. 8; 902 in FIG. 9)), e.g., different than the first resolution (e.g., 4:1 in FIG. 5). The second FOV (e.g., 602 in FIG. 6; 702 in FIG. 7; 802 in FIG. 8; 902 in FIG. 9) may include a first overlap (e.g., 708, 710 in FIG. 7; 808, 810 in FIG. 8; 908, 910 in FIG. 9) of the first FOV (e.g., 606 in FIG. 6; 706 in FIG. 7; 806 in FIG. 8; 906 in FIG. 9) and may be surrounded on at least two second FOV sides by the first FOV (e.g., 606 in FIG. 6; 706 in FIG. 7; 806 in FIG. 8; 906 in FIG. 9). In aspects, first data for pixels associated with the first overlap (e.g., 708, 710 in FIG. 7; 808, 810 in FIG. 8; 908, 910 in FIG. 9) of the first FOV (e.g., 606 in FIG. 6; 706 in FIG. 7; 806 in FIG. 8; 906 in FIG. 9) may be outside of the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) (e.g., is excluded from the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) and not stored at the contiguous portion of memory 1304 (e.g., 817 in FIG. 8; 917 in FIG. 9; 1217 in FIG. 12)). In aspects, to obtain (at 1308) the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) associated with the first pixels for the first FOV (e.g., 606 in FIG. 6; 706 in FIG. 7; 806 in FIG. 8; 906 in FIG. 9) of image data (e.g., 598 in FIG. 5; 898 in FIG. 8), the contiguous portion of memory 1304 (e.g., 817 in FIG. 8; 917 in FIG. 9; 1217 in FIG. 12) may be configured to store the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) associated with the first pixels for the first FOV (e.g., 606 in FIG. 6; 706 in FIG. 7; 806 in FIG. 8; 906 in FIG. 9) of image data (e.g., 598 in FIG. 5; 898 in FIG. 8), and to refrain from storing the first data for pixels associated with the first overlap (e.g., 708, 710 in FIG. 7; 808, 810 in FIG. 8; 908, 910 in FIG. 9) of the first FOV (e.g., 606 in FIG. 6; 706 in FIG. 7; 806 in FIG. 8; 906 in FIG. 9). In some aspects, to obtain the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12), the contiguous portion of memory 1304 (e.g., 817 in FIG. 8; 917 in FIG. 9; 1217 in FIG. 12) may be configured to receive the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) from the data processor 1302, from a VST sensor, and/or from a foveated sensor. In an example, 1502 may be performed by the compute gating controller 198.

At 1504, the apparatus may determine, with reference to a first data line of the first set of data lines, that the contiguous portion of memory includes a first number of prior data lines of the first set of data lines and a second number of subsequent data lines of the first set of data lines. For example, referring to FIG. 13, at 1310, the contiguous portion of memory 1304 (e.g., 817 in FIG. 8; 917 in FIG. 9; 1217 in FIG. 12) may determine (e.g., at 1030, at 1032 in FIG. 10; at 1130, at 1132 in FIG. 11; at 1230 in FIG. 12), with reference to a first data line 1314 (e.g., lines 0/1, lines 8/9 in

FIG. 10; lines 16/17 in FIG. 11; lines 32/33, lines 34/35 in FIG. 12) of the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12), that the contiguous portion of memory 1304 (e.g., 817 in FIG. 8; 917 in FIG. 9; 1217 in FIG. 12) includes a first number of prior data lines (e.g., lines-2/-1, lines 0/1 in FIG. 10; lines 12/13, lines 16/17 in FIG. 11; lines 24/25, lines 28/29 in FIG. 12) of the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) and a second number of subsequent data lines (e.g., lines 8/9, lines 16/17 in FIG. 10; lines 20/21, lines 24/26 in FIG. 11; lines 36/37 in FIG. 12) of the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12). In aspects, the first number of prior data lines (e.g., lines-2/-1, lines 0/1 in FIG. 10; lines 12/13, lines 16/17 in FIG. 11; lines 24/25, lines 28/29 in FIG. 12) may be prior to the second number of subsequent data lines (e.g., lines 8/9, lines 16/17 in FIG. 10; lines 20/21, lines 24/26 in FIG. 11; lines 36/37 in FIG. 12) in the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12). In some aspects, the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) may include initial data lines (e.g., 1002 in FIG. 10; 1104 in FIG. 11) for the first FOV (e.g., 606 in FIG. 6; 706 in FIG. 7; 806 in FIG. 8; 906 in FIG. 9) of the image data (e.g., 598 in FIG. 5; 898 in FIG. 8) and the number of prior data lines may be zero. In such aspects, the prior data lines may be first mirrored data lines (e.g., 1040 in FIG. 10; 1140 in FIG. 11) of the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) or may be first padded data lines (e.g., 1040 in FIG. 10; 1140 in FIG. 11) of a default data value (e.g., zeroes (0's) or ones (1's)). In some aspects, the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) may include final data lines for the first FOV (e.g., 606 in FIG. 6; 706 in FIG. 7; 806 in FIG. 8; 906 in FIG. 9) of the image data (e.g., 598 in FIG. 5; 898 in FIG. 8) and the number of subsequent data lines may be zero. In such aspects, the subsequent data lines may be second mirrored data lines of the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) or may be second padded data lines of a default data value (e.g., zeroes (0's) or ones (1's)). In an example, 1504 may be performed by the compute gating controller 198.

At 1506, the apparatus may output, from the contiguous portion of memory, the first data line of the first set of data lines based on the first number of prior data lines and the second number of subsequent data lines. For example, referring to FIG. 13, at 1312, the contiguous portion of memory 1304 (e.g., 817 in FIG. 8; 917 in FIG. 9; 1217 in FIG. 12) may output (e.g., 818 in FIG. 8) the first data line 1314 (e.g., lines 0/1, lines 8/9 in FIG. 10; lines 16/17 in FIG. 11; lines 32/33, lines 34/35 in FIG. 12) of the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) based on the first number of prior data lines (e.g., lines-2/-1, lines 0/1 in FIG. 10; lines 12/13, lines 16/17 in FIG. 11; lines 24/25, lines 28/29 in FIG. 12) and the second number of subsequent data lines (e.g., lines 8/9, lines 16/17 in FIG. 10; lines 20/21, lines 24/26 in FIG. 11; lines 36/37 in FIG. 12). In aspects, to output (e.g., 818 in FIG. 8) the first data line 1314 (e.g., lines 0/1, lines 8/9 in FIG. 10; lines 16/17 in FIG. 11; lines 32/33, lines 34/35 in FIG. 12) based on the first number of prior data lines (e.g., lines-2/-1, lines 0/1 in FIG. 10; lines 12/13, lines 16/17 in FIG. 11; lines 24/25, lines 28/29 in FIG. 12) and the second number of subsequent data lines (e.g., lines 8/9, lines 16/17 in FIG. 10; lines 20/21, lines 24/26 in FIG. 11; lines 36/37 in FIG. 12), the contiguous portion of memory 1304 (e.g., 817 in FIG. 8; 917 in FIG. 9; 1217 in FIG. 12) may be configured to provide the first data line 1314 (e.g., lines 0/1, lines 8/9 in FIG. 10; lines 16/17 in FIG. 11; lines 32/33, lines 34/35 in FIG. 12) for processing by at least one of an ISP (e.g., 816 in FIG. 8; 1216 in FIG. 12), a graphics processor, or a display processor (e.g., the ISP/GPU/DPU 1305) and/or may be configured to provide the first data line 1314 (e.g., lines 0/1, lines 8/9 in FIG. 10; lines 16/17 in FIG. 11; lines 32/33, lines 34/35 in FIG. 12) to a display panel or a HMD (e.g., 512 in FIG. 5). In an example, 1506 may be performed by the compute gating controller 198.

At 1508, the apparatus may obtain, at the contiguous portion of memory and after the first set of data lines, a second set of data lines associated with second pixels for the second FOV of the image data. For example, referring to FIG. 13, the contiguous portion of memory 1304 (e.g., 817 in FIG. 8; 917 in FIG. 9; 1217 in FIG. 12) may obtain, after the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12), a second set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12) associated with second pixels for the second FOV (e.g., 602 in FIG. 6; 702 in FIG. 7; 802 in FIG. 8; 902 in FIG. 9) of the image data (e.g., 598 in FIG. 5; 898 in FIG. 8). In an example, 1508 may be performed by the compute gating controller 198.

At 1510, the apparatus may determine, with reference to a second data line of the second set of data lines, that the contiguous portion of memory includes a third number of prior data lines of the second set of data lines and a fourth number of subsequent data lines of the second set of data lines. For example, referring to FIG. 13, the contiguous portion of memory 1304 (e.g., 817 in FIG. 8; 917 in FIG. 9; 1217 in FIG. 12) may determine (e.g., at 1030, at 1032 in FIG. 10; at 1130, at 1132 in FIG. 11; at 1230 in FIG. 12), with reference to a second data line (e.g., lines 0/1, lines 8/9 in FIG. 10; lines 16/17 in FIG. 11; lines 32/33, lines 34/35 in FIG. 12) of the second set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12), that the contiguous portion of memory 1304 (e.g., 817 in FIG. 8; 917 in FIG. 9; 1217 in FIG. 12) includes a third number of prior data lines (e.g., lines-2/-1, lines 0/1 in FIG. 10; lines 12/13, lines 16/17 in FIG. 11; lines 24/25, lines 28/29 in FIG. 12) of the second set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12) and a fourth number of subsequent data lines (e.g., lines 8/9, lines 16/17 in FIG. 10; lines 20/21, lines 24/26 in FIG. 11; lines 36/37 in FIG. 12) of the second set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12). In an example, 1510 may be performed by the compute gating controller 198.

At 1512, the apparatus may output, from the contiguous portion of memory, the second data line of the second set of data lines based on the third number of prior data lines and the fourth number of subsequent data lines. For example, referring to FIG. 13, the contiguous portion of memory 1304 (e.g., 817 in FIG. 8; 917 in FIG. 9; 1217 in FIG. 12) may output (e.g., 818 in FIG. 8) the second data line (e.g., lines 0/1, lines 8/9 in FIG. 10; lines 16/17 in FIG. 11; lines 32/33, lines 34/35 in FIG. 12) of the second set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12) based on the third number of prior data lines (e.g., lines-2/-1, lines 0/1 in FIG. 10; lines 12/13, lines 16/17 in FIG. 11; lines 24/25, lines 28/29 in FIG. 12) and the fourth number of subsequent data lines (e.g., lines 8/9, lines 16/17 in FIG. 10; lines 20/21, lines 24/26 in FIG. 11; lines 36/37 in FIG. 12). In aspects, to output (e.g., 818 in FIG. 8) the second data line (e.g., lines 0/1, lines 8/9 in FIG. 10; lines 16/17 in FIG. 11; lines 32/33, lines 34/35 in FIG. 12), the contiguous portion of memory 1304 (e.g., 817 in FIG. 8; 917 in FIG. 9; 1217 in FIG. 12) may be configured to provide the second data line (e.g., lines 0/1, lines 8/9 in FIG. 10; lines 16/17 in FIG. 11; lines 32/33, lines 34/35 in FIG. 12) for processing by at least one of an ISP (e.g., 816 in FIG. 8; 1216 in FIG. 12), a graphics processor, or a display processor (e.g., the ISP/GPU/DPU 1305) and/or may be configured to provide the second data line (e.g., lines 0/1, lines 8/9 in FIG. 10; lines 16/17 in FIG. 11; lines 32/33, lines 34/35 in FIG. 12) to a display panel or a HMD (e.g., 512 in FIG. 5). In an example, 1512 may be performed by the compute gating controller 198.

At 1514, the apparatus may obtain, at the contiguous portion of memory before the second set of data lines and after the first set of data lines, a third set of data lines associated with third pixels for a third FOV of the image data, where: the third FOV of the image data corresponds to a third resolution for the image data, where the third FOV includes a second overlap of the first FOV and is surrounded on at least two third FOV sides by the first FOV, the second FOV is surrounded on the at least two second FOV sides by the third FOV and includes a third overlap of the third FOV, the first set of data lines is exclusive of second data for pixels associated with the second overlap of the first FOV, and the third set of data lines is exclusive of third data for pixels associated with the third overlap of the third FOV. For example, referring to FIG. 13, the contiguous portion of memory 1304 (e.g., 817 in FIG. 8; 917 in FIG. 9; 1217 in FIG. 12) may obtain, before the second set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12) and after the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12), a third set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12) associated with third pixels for a third FOV (e.g., 604 in FIG. 6; 704 in FIG. 7; 804 in FIG. 8; 904 in FIG. 9) of the image data (e.g., 598 in FIG. 5; 898 in FIG. 8). In aspects, the third FOV (e.g., 604 in FIG. 6; 704 in FIG. 7; 804 in FIG. 8; 904 in FIG. 9) of the image data (e.g., 598 in FIG. 5; 898 in FIG. 8) may correspond to a third resolution (e.g., 2:1 in FIG. 5) for the image data (e.g., 598 in FIG. 5; 898 in FIG. 8), and the third FOV (e.g., 604 in FIG. 6; 704 in FIG. 7; 804 in FIG. 8; 904 in FIG. 9) may include a second overlap (e.g., 708, 710 in FIG. 7; 808, 810 in FIG. 8; 908, 910 in FIG. 9) of the first FOV and may be surrounded on at least two third FOV sides by the first FOV (e.g., 606 in FIG. 6; 706 in FIG. 7; 806 in FIG. 8; 906 in FIG. 9). In aspects, the second FOV (e.g., 602 in FIG. 6; 702 in FIG. 7; 802 in FIG. 8; 902 in FIG. 9) may be surrounded on at least two second FOV sides by the third FOV (e.g., 604 in FIG. 6; 704 in FIG. 7; 804 in FIG. 8; 904 in FIG. 9) and may include a third overlap (e.g., 708, 710 in FIG. 7; 808, 810 in FIG. 8; 908, 910 in FIG. 9) of the third FOV (e.g., 604 in FIG. 6; 704 in FIG. 7; 804 in FIG. 8; 904 in FIG. 9). In aspects, the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) may be exclusive of second data for pixels (e.g., 714 in FIG. 7) associated with the second overlap (e.g., 708, 710 in FIG. 7; 808, 810 in FIG. 8; 908, 910 in FIG. 9) of the first FOV (e.g., 606 in FIG. 6; 706 in FIG. 7; 806 in FIG. 8; 906 in FIG. 9), and the third set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12) may be exclusive of third data for pixels (e.g., 714 in FIG. 7) associated with the third overlap (e.g., 708, 710 in FIG. 7; 808, 810 in FIG. 8; 908, 910 in FIG. 9) of the third FOV (e.g., 604 in FIG. 6; 704 in FIG. 7; 804 in FIG. 8; 904 in FIG. 9). That is, pixel data (e.g., 714 in FIG. 7) associated with overlapping FOVs may not be stored at the contiguous portion of memory 1304 (e.g., 817 in FIG. 8; 917 in FIG. 9; 1217 in FIG. 12). In an example, 1514 may be performed by the compute gating controller 198.

At 1516, the apparatus may determine, with reference to a third data line of the third set of data lines, that the contiguous portion of memory includes a fifth number of prior data lines of the third set of data lines and a sixth number of subsequent data lines of the third set of data lines, where the fifth number of prior data lines is prior to the sixth number of subsequent data lines in the third set of data lines. For example, referring to FIG. 13, the contiguous portion of memory 1304 (e.g., 817 in FIG. 8; 917 in FIG. 9; 1217 in FIG. 12) may determine (e.g., at 1030, at 1032 in FIG. 10; at 1130, at 1132 in FIG. 11; at 1230 in FIG. 12), with reference to a third data line (e.g., lines 0/1, lines 8/9 in FIG. 10; lines 16/17 in FIG. 11; lines 32/33, lines 34/35 in FIG. 12) of the third set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12), that the contiguous portion of memory 1304 (e.g., 817 in FIG. 8; 917 in FIG. 9; 1217 in FIG. 12) include a fifth number of prior data lines (e.g., lines-2/-1, lines 0/1 in FIG. 10; lines 12/13, lines 16/17 in FIG. 11; lines 24/25, lines 28/29 in FIG. 12) of the third set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12) and a sixth number of subsequent data lines (e.g., lines 8/9, lines 16/17 in FIG. 10; lines 20/21, lines 24/26 in FIG. 11; lines 36/37 in FIG. 12) of the third set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12), and the fifth number of prior data lines (e.g., lines-2/-1, lines 0/1 in FIG. 10; lines 12/13, lines 16/17 in FIG. 11; lines 24/25, lines 28/29 in FIG. 12) may be prior to the sixth number of subsequent data lines (e.g., lines 8/9, lines 16/17 in FIG. 10; lines 20/21, lines 24/26 in FIG. 11; lines 36/37 in FIG. 12) in the third set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12). In aspects, the contiguous portion of memory 1304 (e.g., 817 in FIG. 8; 917 in FIG. 9; 1217 in FIG. 12) may output (e.g., 818 in FIG. 8) the third data line (e.g., lines 0/1, lines 8/9 in FIG. 10; lines 16/17 in FIG. 11; lines 32/33, lines 34/35 in FIG. 12) of the third set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12) based on the fifth number of prior data lines (e.g., lines-2/-1, lines 0/1 in FIG. 10; lines 12/13, lines 16/17 in FIG. 11; lines 24/25, lines 28/29 in FIG. 12) and the sixth number of subsequent data lines (e.g., lines 8/9, lines 16/17 in FIG. 10; lines 20/21, lines 24/26 in FIG. 11; lines 36/37 in FIG. 12). In an example, 1516 may be performed by the compute gating controller 198.

At 1518, the apparatus may output, from the contiguous portion of memory, the third data line of the third set of data lines based on the fifth number of prior data lines and the sixth number of subsequent data lines. For example, referring to FIG. 13, to output (e.g., 818 in FIG. 8) the third data line (e.g., lines 0/1, lines 8/9 in FIG. 10; lines 16/17 in FIG. 11; lines 32/33, lines 34/35 in FIG. 12), the contiguous portion of memory 1304 (e.g., 817 in FIG. 8; 917 in FIG. 9; 1217 in FIG. 12) may be configured to provide the third data line (e.g., lines 0/1, lines 8/9 in FIG. 10; lines 16/17 in FIG. 11; lines 32/33, lines 34/35 in FIG. 12) for processing by at least one of an ISP (e.g., 816 in FIG. 8; 1216 in FIG. 12), a graphics processor, or a display processor (e.g., the ISP/GPU/DPU 1305) and/or may be configured to provide the third data line (e.g., lines 0/1, lines 8/9 in FIG. 10; lines 16/17 in FIG. 11; lines 32/33, lines 34/35 in FIG. 12) to a display panel or a HMD (e.g., 512 in FIG. 5).

In some aspects, the contiguous portion of memory 1304 (e.g., 817 in FIG. 8; 917 in FIG. 9; 1217 in FIG. 12) may be configured to output (e.g., 818 in FIG. 8) any combination of the first data line 1314 (e.g., lines 0/1, lines 8/9 in FIG. 10; lines 16/17 in FIG. 11; lines 32/33, lines 34/35 in FIG. 12) (e.g., at 1506), the second data line (e.g., lines 0/1, lines 8/9 in FIG. 10; lines 16/17 in FIG. 11; lines 32/33, lines 34/35 in FIG. 12) (e.g., at 1512), or the third data line (e.g., lines 0/1, lines 8/9 in FIG. 10; lines 16/17 in FIG. 11; lines 32/33, lines 34/35 in FIG. 12) (e.g., at 1518) concurrently or at least partially concurrently.

In aspects, the first number of prior data lines (e.g., lines-2/-1, lines 0/1 in FIG. 10; lines 12/13, lines 16/17 in FIG. 11; lines 24/25, lines 28/29 in FIG. 12), the third number of prior data lines (e.g., lines-2/-1, lines 0/1 in FIG. 10; lines 12/13, lines 16/17 in FIG. 11; lines 24/25, lines 28/29 in FIG. 12), the fifth number of prior data lines (e.g., lines-2/-1, lines 0/1 in FIG. 10; lines 12/13, lines 16/17 in FIG. 11; lines 24/25, lines 28/29 in FIG. 12), the second number of subsequent data lines (e.g., lines 8/9, lines 16/17 in FIG. 10; lines 20/21, lines 24/26 in FIG. 11; lines 36/37 in FIG. 12), the fourth number of subsequent data lines (e.g., lines 8/9, lines 16/17 in FIG. 10; lines 20/21, lines 24/26 in FIG. 11; lines 36/37 in FIG. 12), and the sixth number of subsequent data lines (e.g., lines 8/9, lines 16/17 in FIG. 10; lines 20/21, lines 24/26 in FIG. 11; lines 36/37 in FIG. 12) may be based on a data line configuration of a kernel (e.g., 1299 in FIG. 12) associated with an ISP (e.g., 816 in FIG. 8; 1216 in FIG. 12) and the contiguous portion of memory 1304 (e.g., 817 in FIG. 8; 917 in FIG. 9; 1217 in FIG. 12).

In aspects, contiguous portion of memory 1304 (e.g., 817 in FIG. 8; 917 in FIG. 9; 1217 in FIG. 12) may include a first buffer (e.g., 826 in FIG. 8; 926 in FIG. 9; 1226 in FIG. 12) that corresponds to the first FOV (e.g., 606 in FIG. 6; 706 in FIG. 7; 806 in FIG. 8; 906 in FIG. 9), a second buffer (e.g., 822 in FIG. 8; 922 in FIG. 9; 1222 in FIG. 12) that corresponds to the second FOV (e.g., 602 in FIG. 6; 702 in FIG. 7; 802 in FIG. 8; 902 in FIG. 9) and is separate from the first buffer (e.g., 826 in FIG. 8; 926 in FIG. 9; 1226 in FIG. 12), and a third buffer (e.g., 824 in FIG. 8; 924 in FIG. 9; 1224 in FIG. 12) that corresponds to the third FOV (e.g., 604 in FIG. 6; 704 in FIG. 7; 804 in FIG. 8; 904 in FIG. 9) and is separate from both of the first buffer (e.g., 826 in FIG. 8; 926 in FIG. 9; 1226 in FIG. 12) and the second buffer (e.g., 822 in FIG. 8; 922 in FIG. 9; 1222 in FIG. 12). At least one of the first buffer (e.g., 826 in FIG. 8; 926 in FIG. 9; 1226 in FIG. 12) or the third buffer (e.g., 824 in FIG. 8; 924 in FIG. 9; 1224 in FIG. 12) may have an area (e.g., a size), based on compute gating (e.g., associated with regions of the image data (e.g., 598 in FIG. 5; 898 in FIG. 8)), that is less than a maximum area for total pixel data (e.g., 712 and 714 in FIG. 7) that corresponds to the first FOV (e.g., 606 in FIG. 6; 706 in FIG. 7; 806 in FIG. 8; 906 in FIG. 9) for the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12) or the third FOV (e.g., 604 in FIG. 6; 704 in FIG. 7; 804 in FIG. 8; 904 in FIG. 9) for the third set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12), respectively. In some aspects, the area may include a margin area (e.g., 1223, 1225, 1227 in FIG. 12), and the margin area (e.g., 1223, 1225, 1227 in FIG. 12) may be based on a context timing stagger of data lines (e.g., lines 0/1, lines 8/9 in FIG. 10; lines 16/17 in FIG. 11; lines 32/33, lines 34/35 in FIG. 12) for at least one of the first FOV (e.g., 606 in FIG. 6; 706 in FIG. 7; 806 in FIG. 8; 906 in FIG. 9), the second FOV (e.g., 602 in FIG. 6; 702 in FIG. 7; 802 in FIG. 8; 902 in FIG. 9), or the third FOV (e.g., 604 in FIG. 6; 704 in FIG. 7; 804 in FIG. 8; 904 in FIG. 9). The margin area (e.g., 1223, 1225, 1227 in FIG. 12) may correspond to at least one additional data line (e.g., lines 0/1, lines 8/9 in FIG. 10; lines 16/17 in FIG. 11; lines 32/33, lines 34/35 in FIG. 12) associated with the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12), the second set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12), or the third set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12), and the area may be greater than a minimum area for pixel data of the first set of data lines 1306 (e.g., 660 in FIG. 6; 870 in FIG. 8; 932, 934, 936 in FIG. 9; 1050, 1052 in FIG. 10; 1150, 1152 in FIG. 11; 1250 in FIG. 12), the second set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12), or the third set of data lines (e.g., 660 in FIG. 6; 870 in FIG. 8; 932, 934, 936 in FIG. 9; 1050, 1052 in FIG. 10; 1150, 1152 in FIG. 11; 1250 in FIG. 12) by a size of the margin area (e.g., 1223, 1225, 1227 in FIG. 12). A first FOV may correspond to a periphery FOV (e.g., 606 in FIG. 6; 706 in FIG. 7; 806 in FIG. 8; 906 in FIG. 9), a second FOV may correspond to a fovea FOV (e.g., 602 in FIG. 6; 702 in FIG. 7; 802 in FIG. 8; 902 in FIG. 9), and a third FOV may correspond to a mid-fovea FOV (e.g., 604 in FIG. 6; 704 in FIG. 7; 804 in FIG. 8; 904 in FIG. 9). In an example, 1518 may be performed by the compute gating controller 198.

In configurations, a method or an apparatus for data processing is provided. The apparatus may be a GPU, a CPU, or some other processor that may perform data or graphics processing. In aspects, the apparatus may be the processing unit 120 within the device 104, or may be some other hardware within the device 104 or another device. The apparatus may include means for obtaining, at a contiguous portion of memory, a first set of data lines associated with first pixels for a first field of view (FOV) of image data, where the first FOV of the image data corresponds to a first resolution for the image data and a second FOV of the image data corresponds to a second resolution, where the second FOV includes a first overlap of the first FOV and is surrounded on at least two second FOV sides by the first FOV, and where first data for pixels associated with the first overlap of the first FOV is outside of the first set of data lines; means for determining, with reference to a first data line of the first set of data lines, that the contiguous portion of memory includes a first number of prior data lines of the first set of data lines and a second number of subsequent data lines of the first set of data lines, where the first number of prior data lines is prior to the second number of subsequent data lines in the first set of data lines; and means for outputting, from the contiguous portion of memory, the first data line of the first set of data lines based on the first number of prior data lines and the second number of subsequent data lines. The apparatus may further include means for obtaining, at the contiguous portion of memory and after the first set of data lines, a second set of data lines associated with second pixels for the second FOV of the image data, means for determining, with reference to a second data line of the second set of data lines, that the contiguous portion of memory includes a third number of prior data lines of the second set of data lines and a fourth number of subsequent data lines of the second set of data lines, and means for outputting, from the contiguous portion of memory, the second data line of the second set of data lines based on the third number of prior data lines and the fourth number of subsequent data lines. The apparatus may further include means for obtaining, at the contiguous portion of memory before the second set of data lines and after the first set of data lines, a third set of data lines associated with third pixels for a third FOV of the image data, where: the third FOV of the image data corresponds to a third resolution for the image data, where the third FOV includes a second overlap of the first FOV and is surrounded on at least two third FOV sides by the first FOV, the second FOV is surrounded on the at least two second FOV sides by the third FOV and includes a third overlap of the third FOV, the first set of data lines is exclusive of second data for pixels associated with the second overlap of the first FOV, and the third set of data lines is exclusive of third data for pixels associated with the third overlap of the third FOV, means for determining, with reference to a third data line of the third set of data lines, that the contiguous portion of memory includes a fifth number of prior data lines of the third set of data lines and a sixth number of subsequent data lines of the third set of data lines, where the fifth number of prior data lines is prior to the sixth number of subsequent data lines in the third set of data lines, and means for outputting, from the contiguous portion of memory, the third data line of the third set of data lines based on the fifth number of prior data lines and the sixth number of subsequent data lines.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of data processing, comprising: obtaining, at a contiguous portion of memory, a first set of data lines associated with first pixels for a first field of view (FOV) of image data, wherein the first FOV of the image data corresponds to a first resolution for the image data and a second FOV of the image data corresponds to a second resolution, wherein the second FOV includes a first overlap of the first FOV and is surrounded on at least two second FOV sides by the first FOV, and wherein first data for pixels associated with the first overlap of the first FOV is outside of the first set of data lines; determining, with reference to a first data line of the first set of data lines, that the contiguous portion of memory includes a first number of prior data lines of the first set of data lines and a second number of subsequent data lines of the first set of data lines, wherein the first number of prior data lines is prior to the second number of subsequent data lines in the first set of data lines; and outputting, from the contiguous portion of memory, the first data line of the first set of data lines based on the first number of prior data lines and the second number of subsequent data lines.

Aspect 2 is the method of aspect 1, further comprising: obtaining, at the contiguous portion of memory and after the first set of data lines, a second set of data lines associated with second pixels for the second FOV of the image data; determining, with reference to a second data line of the second set of data lines, that the contiguous portion of memory includes a third number of prior data lines of the second set of data lines and a fourth number of subsequent data lines of the second set of data lines; and outputting, from the contiguous portion of memory, the second data line of the second set of data lines based on the third number of prior data lines and the fourth number of subsequent data lines.

Aspect 3 is the method of aspect 2, further comprising: obtaining, at the contiguous portion of memory before the second set of data lines and after the first set of data lines, a third set of data lines associated with third pixels for a third FOV of the image data, wherein: the third FOV of the image data corresponds to a third resolution for the image data, wherein the third FOV includes a second overlap of the first FOV and is surrounded on at least two third FOV sides by the first FOV, the second FOV is surrounded on the at least two second FOV sides by the third FOV and includes a third overlap of the third FOV, the first set of data lines is exclusive of second data for pixels associated with the second overlap of the first FOV, and the third set of data lines is exclusive of third data for pixels associated with the third overlap of the third FOV; determining, with reference to a third data line of the third set of data lines, that the contiguous portion of memory includes a fifth number of prior data lines of the third set of data lines and a sixth number of subsequent data lines of the third set of data lines, wherein the fifth number of prior data lines is prior to the sixth number of subsequent data lines in the third set of data lines; and outputting, from the contiguous portion of memory, the third data line of the third set of data lines based on the fifth number of prior data lines and the sixth number of subsequent data lines.

Aspect 4 is the method of aspect 3, wherein the first number of prior data lines, the third number of prior data lines, the fifth number of prior data lines, the second number of subsequent data lines, the fourth number of subsequent data lines, and the sixth number of subsequent data lines are based on a data line configuration of a kernel associated with an image signal processor (ISP) and the contiguous portion of memory.

Aspect 5 is the method of aspect 3, wherein the contiguous portion of memory includes a first buffer that corresponds to the first FOV, a second buffer that corresponds to the second FOV and is separate from the first buffer, and a third buffer that corresponds to the third FOV and is separate from both of the first buffer and the second buffer.

Aspect 6 is the method of aspect 5, wherein at least one of the first buffer, the second buffer, or the third buffer is dynamically allocated in the contiguous portion of memory, wherein at least one of the first buffer or the third buffer has an area based on compute gating, associated with regions of the image data, that is less than a maximum area for total pixel data that corresponds to the first FOV for the first set of data lines or the third FOV for the third set of data lines, respectively.

Aspect 7 is the method of aspect 6, wherein the area includes a margin area, wherein the margin area is based on context timing stagger of data lines for at least one of the first FOV, the second FOV, or the third FOV, wherein the margin area corresponds to at least one additional data line associated with the first set of data lines, the second set of data lines, or the third set of data lines, and wherein the area is greater than a minimum area for pixel data of the first set of data lines, the second set of data lines, or the third set of data lines by a size of the margin area.

Aspect 8 is the method of aspect 5, wherein the first FOV corresponds to a periphery FOV, the second FOV corresponds to a fovea FOV, and the third FOV corresponds to a mid-fovea FOV.

Aspect 9 is the method of aspect 3, wherein at least two of outputting the first data line, outputting the second data line, or outputting the third data line are performed concurrently.

Aspect 10 is the method of any of aspects 1 to 9, wherein the first set of data lines includes initial data lines for the first FOV of the image data and the number of prior data lines is zero, wherein the prior data lines are first mirrored data lines of the first set of data lines or are first padded data lines of a default data value.

Aspect 11 is the method of any of aspects 1 to 9, wherein the first set of data lines includes final data lines for the first FOV of the image data and the number of subsequent data lines is zero, wherein the subsequent data lines are second mirrored data lines of the first set of data lines or are second padded data lines of the default data value.

Aspect 12 is the method of any of aspects 1 to 11, wherein outputting, from the contiguous portion of memory, the first data line based on the first number of prior data lines and the second number of subsequent data lines, includes at least one of: providing the first data line for processing by at least one of an image signal processor (ISP), a graphics processor, or a display processor; or providing the first data line to a display panel or a head-mounted device (HMD).

Aspect 13 is the method of any of aspects 1 to 12, wherein obtaining, at the contiguous portion of memory, the first set of data lines associated with the first pixels for the first FOV of the image data, includes: storing at the contiguous portion of memory, the first set of data lines associated with the first pixels for the first FOV of the image data; and refraining from storing the first data for pixels associated with the first overlap of the first FOV.

Aspect 14 is an apparatus for data processing comprising a processor coupled to a memory and, based on information stored in the memory, the processor is configured to implement a method as in any of aspects 1-13.

Aspect 15 may be combined with aspect 14 and comprises that the apparatus is a wireless communication device.

Aspect 16 is an apparatus for data processing comprising means for implementing a method as in any of aspects 1-13.

Aspect 17 is a computer-readable medium (e.g., a non-transitory computer readable-medium) storing computer executable code, the computer executable code, when executed by a processor, causes the processor to implement a method as in any of aspects 1-13.

Various aspects have been described herein. These and other aspects are within the scope of the following claims.

What is claimed is:

1. An apparatus for data processing, comprising:
an apparatus memory; and
a processor coupled to the apparatus memory and, based on information stored in the apparatus memory, the processor is configured to:
obtain, at a contiguous portion of memory, a first set of data lines associated with first pixels for a first field of view (FOV) of image data, wherein the first FOV of the image data corresponds to a first resolution for the image data and a second FOV of the image data corresponds to a second resolution, wherein the second FOV includes a first overlap of the first FOV and is surrounded on at least two second FOV sides by the first FOV, and wherein first data for pixels associated with the first overlap of the first FOV is outside of the first set of data lines;
determine, with reference to a first data line of the first set of data lines, that the contiguous portion of memory includes a first number of prior data lines of the first set of data lines and a second number of subsequent data lines of the first set of data lines, wherein the first number of prior data lines is prior to the second number of subsequent data lines in the first set of data lines; and
output, from the contiguous portion of memory, the first data line of the first set of data lines based on the first number of prior data lines and the second number of subsequent data lines.

2. The apparatus of claim 1, wherein the processor is further configured to:
obtain, at the contiguous portion of memory and after the first set of data lines, a second set of data lines associated with second pixels for the second FOV of the image data;
determine, with reference to a second data line of the second set of data lines, that the contiguous portion of memory includes a third number of prior data lines of the second set of data lines and a fourth number of subsequent data lines of the second set of data lines; and
output, from the contiguous portion of memory, the second data line of the second set of data lines based on the third number of prior data lines and the fourth number of subsequent data lines.

3. The apparatus of claim 2, wherein the processor is further configured to:
obtain, at the contiguous portion of memory before the second set of data lines and after the first set of data lines, a third set of data lines associated with third pixels for a third FOV of the image data, wherein:
the third FOV of the image data corresponds to a third resolution for the image data, wherein the third FOV includes a second overlap of the first FOV and is surrounded on at least two third FOV sides by the first FOV,
the second FOV is surrounded on the at least two second FOV sides by the third FOV and includes a third overlap of the third FOV,
the first set of data lines is exclusive of second data for pixels associated with the second overlap of the first FOV, and
the third set of data lines is exclusive of third data for pixels associated with the third overlap of the third FOV;
determine, with reference to a third data line of the third set of data lines, that the contiguous portion of memory includes a fifth number of prior data lines of the third set of data lines and a sixth number of subsequent data lines of the third set of data lines, wherein the fifth number of prior data lines is prior to the sixth number of subsequent data lines in the third set of data lines; and
output, from the contiguous portion of memory, the third data line of the third set of data lines based on the fifth number of prior data lines and the sixth number of subsequent data lines.

4. The apparatus of claim 3, wherein the first number of prior data lines, the third number of prior data lines, the fifth number of prior data lines, the second number of subsequent data lines, the fourth number of subsequent data lines, and the sixth number of subsequent data lines are based on a data line configuration of a kernel associated with an image signal processor (ISP) and the contiguous portion of memory.

5. The apparatus of claim 3, wherein the contiguous portion of memory includes a first buffer that corresponds to the first FOV, a second buffer that corresponds to the second FOV and is separate from the first buffer, and a third buffer that corresponds to the third FOV and is separate from both of the first buffer and the second buffer.

6. The apparatus of claim 5, wherein at least one of the first buffer, the second buffer, or the third buffer is dynamically allocated in the contiguous portion of memory, wherein at least one of the first buffer or the third buffer has an area based on compute gating, associated with regions of the image data, that is less than a maximum area for total pixel data that corresponds to the first FOV for the first set of data lines or the third FOV for the third set of data lines, respectively.

7. The apparatus of claim 6, wherein the area includes a margin area, wherein the margin area is based on context timing stagger of data lines for at least one of the first FOV, the second FOV, or the third FOV, wherein the margin area corresponds to at least one additional data line associated with the first set of data lines, the second set of data lines, or the third set of data lines, and wherein the area is greater than a minimum area for pixel data of the first set of data lines, the second set of data lines, or the third set of data lines by a size of the margin area.

8. The apparatus of claim 5, wherein the first FOV corresponds to a periphery FOV, the second FOV corresponds to a fovea FOV, and the third FOV corresponds to a mid-fovea FOV.

9. The apparatus of claim 3, wherein the processor is configured to at least two of output the first data line, output the second data line, or output the third data line concurrently.

10. The apparatus of claim 1, wherein the first set of data lines includes initial data lines for the first FOV of the image data and the number of prior data lines is zero, wherein the prior data lines are first mirrored data lines of the first set of data lines or are first padded data lines of a default data value.

11. The apparatus of claim 1, wherein the first set of data lines includes final data lines for the first FOV of the image data and the number of subsequent data lines is zero, wherein the subsequent data lines are second mirrored data lines of the first set of data lines or are second padded data lines of a default data value.

12. The apparatus of claim 1, wherein to output, from the contiguous portion of memory, the first data line based on the first number of prior data lines and the second number of subsequent data lines, the processor is configured to at least one of:
provide the first data line for processing by at least one of an image signal processor (ISP), a graphics processor, or a display processor; or
provide the first data line to a display panel or a head-mounted device (HMD).

13. The apparatus of claim 1, wherein to obtain, at the contiguous portion of memory, the first set of data lines associated with the first pixels for the first FOV of the image data, the processor is configured to:
store at the contiguous portion of memory, the first set of data lines associated with the first pixels for the first FOV of the image data; and
refrain from storing the first data for pixels associated with the first overlap of the first FOV.

14. The apparatus of claim 1, wherein the apparatus is a wireless communication device.

15. A method of data processing, comprising:
obtaining, at a contiguous portion of memory, a first set of data lines associated with first pixels for a first field of view (FOV) of image data, wherein the first FOV of the image data corresponds to a first resolution for the image data and a second FOV of the image data corresponds to a second resolution, wherein the second FOV includes a first overlap of the first FOV and is surrounded on at least two second FOV sides by the first FOV, and wherein first data for pixels associated with the first overlap of the first FOV is outside of the first set of data lines;
determining, with reference to a first data line of the first set of data lines, that the contiguous portion of memory includes a first number of prior data lines of the first set of data lines and a second number of subsequent data lines of the first set of data lines, wherein the first number of prior data lines is prior to the second number of subsequent data lines in the first set of data lines; and
outputting, from the contiguous portion of memory, the first data line of the first set of data lines based on the first number of prior data lines and the second number of subsequent data lines.

16. The method of claim 15, further comprising:
obtaining, at the contiguous portion of memory and after the first set of data lines, a second set of data lines associated with second pixels for the second FOV of the image data;
determining, with reference to a second data line of the second set of data lines, that the contiguous portion of memory includes a third number of prior data lines of the second set of data lines and a fourth number of subsequent data lines of the second set of data lines; and
outputting, from the contiguous portion of memory, the second data line of the second set of data lines based on the third number of prior data lines and the fourth number of subsequent data lines.

17. The method of claim 16, further comprising:
obtaining, at the contiguous portion of memory before the second set of data lines and after the first set of data lines, a third set of data lines associated with third pixels for a third FOV of the image data, wherein:
the third FOV of the image data corresponds to a third resolution for the image data, wherein the third FOV includes a second overlap of the first FOV and is surrounded on at least two third FOV sides by the first FOV,
the second FOV is surrounded on the at least two second FOV sides by the third FOV and includes a third overlap of the third FOV,
the first set of data lines is exclusive of second data for pixels associated with the second overlap of the first FOV, and
the third set of data lines is exclusive of third data for pixels associated with the third overlap of the third FOV;
determining, with reference to a third data line of the third set of data lines, that the contiguous portion of memory includes a fifth number of prior data lines of the third set of data lines and a sixth number of subsequent data lines of the third set of data lines, wherein the fifth number of prior data lines is prior to the sixth number of subsequent data lines in the third set of data lines; and
outputting, from the contiguous portion of memory, the third data line of the third set of data lines based on the fifth number of prior data lines and the sixth number of subsequent data lines.

18. The method of claim 17, wherein the first number of prior data lines, the third number of prior data lines, the fifth number of prior data lines, the second number of subsequent data lines, the fourth number of subsequent data lines, and the sixth number of subsequent data lines are based on a data line configuration of a kernel associated with an image signal processor (ISP) and the contiguous portion of memory;
wherein the contiguous portion of memory includes a first buffer that corresponds to the first FOV, a second buffer that corresponds to the second FOV and is separate from the first buffer, and a third buffer that corresponds to the third FOV and is separate from both of the first buffer and the second buffer;
wherein at least two of outputting the first data line, outputting the second data line, or outputting the third data line are performed concurrently;
wherein the first set of data lines includes initial data lines for the first FOV of the image data and the number of prior data lines is zero, wherein the prior data lines are first mirrored data lines of the first set of data lines or are first padded data lines of a default data value; or
wherein the first set of data lines includes final data lines for the first FOV of the image data and the number of subsequent data lines is zero, wherein the subsequent data lines are second mirrored data lines of the first set of data lines or are second padded data lines of the default data value.

19. The method of claim 18, wherein at least one of the first buffer, the second buffer, or the third buffer is dynamically allocated in the contiguous portion of memory, wherein at least one of the first buffer or the third buffer has an area based on compute gating, associated with regions of the image data, that is less than a maximum area for total pixel data that corresponds to the first FOV for the first set of data lines or the third FOV for the third set of data lines, respectively; or
wherein the first FOV corresponds to a periphery FOV, the second FOV corresponds to a fovea FOV, and the third FOV corresponds to a mid-fovea FOV.

20. A computer-readable medium storing computer executable code, the computer executable code, when executed by a processor, causes the processor to:
obtain, at a contiguous portion of memory, a first set of data lines associated with first pixels for a first field of view (FOV) of image data, wherein the first FOV of the image data corresponds to a first resolution for the image data and a second FOV of the image data corresponds to a second resolution, wherein the second FOV includes a first overlap of the first FOV and is surrounded on at least two second FOV sides by the first FOV, and wherein first data for pixels associated with the first overlap of the first FOV is outside of the first set of data lines;
determine, with reference to a first data line of the first set of data lines, that the contiguous portion of memory includes a first number of prior data lines of the first set of data lines and a second number of subsequent data lines of the first set of data lines, wherein the first number of prior data lines is prior to the second number of subsequent data lines in the first set of data lines; and
output, from the contiguous portion of memory, the first data line of the first set of data lines based on the first number of prior data lines and the second number of subsequent data lines.
